(19) United States
(12) Patent Application Publication
(10) Pub. No.: US 2023/0320346 A1
(43) Pub. Date: Oct. 12, 2023

(54) ENCAPSULATED CELLS AND METHODS OF PRESERVING THEREOF

(71) Applicant: Avenge Bio, Inc., Natick, MA (US)

(72) Inventors: Jacob Schladenhauffen, Cambridge, MA (US); Guillaume Carmona, Cambridge, MA (US); Lauren Jansen, Cambridge, MA (US)

(21) Appl. No.: 18/133,843

(22) Filed: Apr. 12, 2023

Related U.S. Application Data
(60) Provisional application No. 63/330,001, filed on Apr. 12, 2022.

(51) Int. Cl. A01N 1/02

(52) U.S. Cl. CPC A01N 1/0221; A01N 1/0284

(57) ABSTRACT

The present disclosure relates to methods of preserving encapsulated cells and related compositions and methods of using the same.

### CROSS-REFERENCE TO RELATED APPLICATIONS

This applications claims priority to U.S. Provisional Application No. 63/330,001, filed Apr. 12, 2022, which is hereby incorporated by reference in its entirety.

### BACKGROUND

Advances in biomedical research have led to methods for localized and targeted therapies for the treatment of diseases, such as cancer; however, in many instances, the percentage of patients responsive to these approaches remains modest (Park et al., Sci. Transl. Med. 10(433) 2018). In addition, many current therapies do not provide a means for controlling delivery of the therapeutic over time (i.e., downregulating or halting production). One approach to overcome these challenges entails use of implantable devices for delivery of therapeutic agents, which can provide local administration of a therapeutic agent in a host in a tunable manner. A need exists to identify implantable devices suitable for this purpose.

### SUMMARY

The present disclosure provides, at least in part, methods of preserving populations of encapsulated cells and related compositions.

In some embodiments, a method of cryopreserving a population of encapsulated cells comprising a plurality of oligonucleotide molecules encoding a heterologous molecule, is provided. In some embodiments, the method comprises: contacting the encapsulated cells with an effective amount of a cryopreservation media to form a cryopreservation composition; optionally, incubating the cryopreservation composition at room temperature prior to cooling; and cooling the cryopreservation composition to a temperature sufficient to cryopreserve the encapsulated cells.

In some embodiments, a method of maintaining viability of a population of encapsulated cells, is provided. In some embodiments, the method comprises the steps of: adding an effective amount of a cryopreservation media to the population of encapsulated cells to form a cryopreservation composition; optionally, incubating the cryopreservation composition at room temperature prior to cooling; cooling the cryopreservation composition to a temperature sufficient to cryopreserve the cells; maintaining the cryopreservation composition at a temperature sufficient to cryopreserve the cells; and thawing the cryopreservation composition under conditions sufficient to maintain viability of the population of encapsulated cells.

In some embodiments, a method of thawing a cryopreserved composition comprising a plurality of encapsulated cells is provided. In some embodiments, the method comprises the steps of thawing the cryopreservation composition; washing the population of encapsulated cells; and replacing the cryopreservation media with basal media.

### BRIEF DESCRIPTION OF DRAWINGS

FIGS. 1A and 1B illustrate cell viability, as measured by cell counting, and antigen production levels, respectively.

FIGS. 2A and 2B illustrate cell viability, as measured by cell counting, and antigen production levels, respectively.

FIGS. 3A and 3B illustrate cell viability, as measured by cell counting, and antigen production levels, respectively.

### DETAILED DESCRIPTION

The present disclosure features methods of preserving populations of encapsulated cells for delivery of an antigenic target (such as a cell and/or therapeutic agent) to a subject in a controlled release manner, and related methods of use thereof. The encapsulated cells described herein comprise a zone or layer that encapsulates or admixes with the antigenic target, preventing contact of a host immune effector cell with the antigenic target to reduce immunoreactivity. In an embodiment, the zone is degradable, and allows for gradual removal of protection against the immune system in the case of encapsulated, therapy-producing cells or the gradual release of the antigenic target to the surrounding tissue or cells in the case where the antigenic target itself is intended for delivery. In some embodiments, the zone or layer is not degradable. In some embodiments, the zone or layer can become fibrosed or is not fibrosed when implanted into a subject (e.g., patient). These embodiments will be described below in more detail.

### I. Definitions

“Antigen molecule,” as used herein, is a substance which induces, activates, or evokes an immune response, e.g., in a subject.

“Cell,” as used herein, refers to an individual cell. In an embodiment, a cell is a primary cell or is derived from a cell culture. In an embodiment, a cell is a stem cell or is derived from a stem cell. A cell may be xenogeneic, autologous, or allogeneic. In an embodiment, a cell is be engineered (e.g., genetically engineered) or is not engineered (e.g., not genetically engineered).

“Degradable,” as used herein, refers to a structure which upon modulation, e.g., cleavage, decreases the ability of the zone of the encapsulated cell (e.g., the inner zone and/or the outer zone) to impede contact of a host immune effector molecule with the zone (e.g., the inner zone and/or the outer zone) or a component disposed in the zone. For example, the degradable entity can comprise a site which is cleavable by an enzyme, e.g., an endogenous host enzyme, or an administered enzyme. Typically, the degradable entity mediates a physical property of a zone, e.g., the inner zone or the outer zone, for example, the thickness, degree of cross-linking, or permeability, which impedes passage of a host agent (e.g., a host immune component, e.g., a host immune cell).

“Immune effector molecule,” as used herein, is a substance which interacts with or regulates an immune response in a subject (e.g., a host). An immune effector molecule may activate the immune response in a subject, repress the immune response in a subject, or modulate (e.g., initiate) immune cell migration in a subject. In an embodiment, the immune effector molecule activates or represses an immune cell in a subject as described herein. Exemplary immune effector molecules include cytokines, such as IL-2, IL-7, IL-10, and IL-12.

“Prevention,” “prevent,” and “preventing” as used herein refers to a treatment that comprises administering or applying a therapy, e.g., administering an encapsulated cell (e.g., as described herein) comprising an antigen molecule or an immune effector molecule prior to the onset of a disease or condition in order to preclude the physical manifestation of said disease or condition. In some embodiments, “prevention,” “prevent,” and “preventing” require that signs or symptoms of the disease or condition have not yet developed or have not yet been observed. In some embodiments, treatment comprises prevention and in other embodiments it does not.

“Subject,” as used herein, refers to the recipient of the encapsulated cell described herein. The subject may include a human and/or other non-human animals, for example, mammals (e.g., primates (e.g., cynomolgus monkeys, rhesus monkeys); commercially relevant mammals such as cattle, pigs, horses, sheep, goats, cats, and/or dogs) and birds (e.g., commercially relevant birds such as chickens, ducks, geese, and/or turkeys). In certain embodiments, the animal is a mammal. The animal may be a male or female and at any stage of development (e.g., a male or female of any age group, e.g., a pediatric subject (e.g., infant, child, adolescent) or adult subject (e.g., young adult, middle-aged adult, or senior adult). A non-human animal may be a transgenic animal.

“Treatment,” “treat,” and “treating,” as used herein, refer to reversing, alleviating, delaying the onset of, or inhibiting the progress of one or more of a symptom, manifestation, or underlying cause of a disease or condition. (e.g., as described herein), e.g., by administering or applying a therapy, e.g., administering an encapsulated cell comprising an antigen molecule or immune effector molecule. In an embodiment, treating comprises reducing, reversing, alleviating, delaying the onset of, or inhibiting the progress of a symptom of a disease, disorder, or condition. In an embodiment, treating comprises reducing, reversing, alleviating, delaying the onset of, or inhibiting the progress of a manifestation of a disease or condition. In an embodiment, treating comprises reducing, reversing, alleviating, reducing, or delaying the onset of, an underlying cause of a disease or condition. In some embodiments, “treatment,” “treat,” and “treating” require that signs or symptoms of the disease or condition have developed or have been observed. In other embodiments, treatment may be administered in the absence of signs or symptoms of the disease or condition, e.g., in preventive treatment. For example, treatment may be administered to a susceptible individual prior to the onset of symptoms (e.g., in light of a history of symptoms and/or in light of genetic or other susceptibility factors). Treatment may also be continued after symptoms have resolved, for example, to delay or prevent recurrence. Treatment may also be continued after symptoms have resolved, for example, to delay or prevent recurrence. In some embodiments, treatment comprises prevention and in other embodiments it does not.

### A. Encapsulated Cells

Encapsulated cells described herein comprise a material that reduces or inhibits a reaction (e.g., such as an immunomodulatory reaction) with or on an antigen molecule or immune effector molecule disposed within. For example, an encapsulated cell comprises a zone or layer that shields an antigen molecule or immune effector molecule from exposure to the surrounding milieu, such as host tissue, host cells, or host cell products. In some embodiments, an encapsulated cell minimizes the effect of a host response (e.g., an immune response) directed at an antigen molecule or immune effector molecule disposed within, e.g., as compared with a similar antigen molecule or immune effector molecule that is not disposed within an encapsulated cell.

In some embodiments, encapsulated cells may comprise a permeable, semi-permeable, or impermeable material to control the flow of solution in and out of the encapsulated cell. For example, the material may be permeable or semi-permeable to allow free passage of small molecules, such as nutrients and waste products, in and out of the encapsulated cell. In addition, the material may be permeable or semi-permeable to allow the transport of an antigen molecule or immune effector molecule out of the encapsulated cell. Exemplary materials include polymers.

In some embodiments, the encapsulated cell comprises a polymer (e.g., a naturally occurring polymer or a synthetic polymer). For example, a polymer may comprise polystyrene, polyester, polycarbonate, polyethylene, polypropylene, polyfluorocarbon, nylon, polyacetylene, polyvinyl chloride (PVC), polyolefin, polyurethane, polyacrylate, polymethacrylate, polyacrylamide, polymethacrylamide, polymethyl methacrylate, poly(2-hydroxyethyl methacrylate), polysiloxane, polydimethylsiloxane (PDMS), polyhydroxyalkanoate, PEEK®, polytetrafluoroethylene, polyethylene glycol, polysulfone, polyacrylonitrile, collagen, cellulose, cellulosic polymers, polysaccharides, polyglycolic acid, poly(L-lactic acid) (PLLA), poly(lactic glycolic acid) (PLGA), polydioxanone (PDA), poly(lactic acid), hyaluronic acid, agarose, alginate, chitosan, or a blend or copolymer thereof. In an embodiment, the encapsulated cell comprises a polysaccharide (e.g., alginate, cellulose, hyaluronic acid, or chitosan). In an embodiment, the encapsulated cell comprises alginate. In some embodiments, the average molecular weight of the polymer is from about 2 kDa to about 500 kDa (e.g., from about 2.5 kDa to about 175 kDa, from about 5 kDa about 150 kDa, from about 10 kDa to about 125 kDa, from about 12.5 kDa to about 100 kDa, from about 15 kDa to about 90 kDa, from about 17.5 kDa to about 80 kDa, from about 20 kDa to about 70 kDa, from about 22.5 kDa to about 60 kDa, or from about 25 kDa to about 50 kDa). In some embodiments, the encapsulated cell comprises at least 0.5%, 1%, 2%, 3%, 4%, 5%, 7.5%, 10%, 15%, 20%, 30%, 40%, 50%, 60%, 70%, 80% or more of a polymer, e.g., a polymer described herein.

In some embodiment, the encapsulated cell comprises a polysaccharide, e.g., an alginate. Alginate is a naturally occurring polymer comprising 0-(1-4)-linked mannuronic acid and guluronic acid residues, and as a result of its high density of negatively charged carboxylates, may be cross-linked with certain cations to form a larger structure, such as a hydrogel. Alginate polymers described herein may have an average molecular weight from about 2 kDa to about 500 kDa (e.g., from about 2.5 kDa to about 175 kDa, from about 5 kDa about 150 kDa, from about 10 kDa to about 125 kDa, from about 12.5 kDa to about 100 kDa, from about 15 kDa to about 90 kDa, from about 17.5 kDa to about about 80 kDa, from about kDa to about 70 kDa, from about 22.5 kDa to about 60 kDa, or from about 25 kDa to about 50 kDa). In some embodiment, the encapsulated cell comprises at least 0.5%, 1%, 2%, 3%, 4%, 5%, 7.5%, 10%, 15%, 20%, 30%, 40%, 50%, 60%, 70%, 80% or more of an alginate polymer. In an embodiment, the alginate is an ultrapure alginate (e.g., SLG20 alginate). In some embodiments, the alginate is SLG20. In some embodiments, the alginate is VLVG (very low viscosity alginate), LVG (low viscosity alginate), MVG (medium viscosity alignate), or SLG100. In some embodiments, the alginate is about 0.1%-3% (w/v) SLG20. In some embodiments, the alginate is about 0.5%-3% (w/v) SLG20. In some embodiments, the alginate is about 0.9%-1.9% (w/v) SLG20. In some embodiments, the alginate is 0.9% (w/v) SLG20. In some embodiments, the alginate is 1% (w/v) SLG20. In some embodiments, the alginate is 1.1% (w/v) SLG20. In some embodiments, the alginate is 1.2% (w/v) SLG20. In some embodiments, the alginate is 1.3% (w/v) SLG20. In some embodiments, the alginate is 1.4% (w/v) SLG20. In some embodiments, the alginate is 1.5% (w/v) SLG20. In some embodiments, the alginate is 1.6% (w/v) SLG20. In some embodiments, the alginate is 1.7% (w/v) SLG20. In some embodiments, the alginate is 1.8% (w/v) SLG20. In some embodiments, the alginate is 1.9% (w/v) SLG20.

In some embodiments, the alginate is about 0.1%-3% (w/v) is VLVG, LVG, MVG, or SLG100. In some embodiments, the alginate is about 0.5%-3% (w/v) VLVG, LVG, MVG, or SLG100. In some embodiments, the alginate is about 0.9%-1.9% (w/v) SLG20. In some embodiments, the alginate is 0.9% (w/v) VLVG, LVG, MVG, or SLG100. In some embodiments, the alginate is 1% (w/v) VLVG, LVG, MVG, or SLG100. In some embodiments, the alginate is 1.1% (w/v) SLG20. In some embodiments, the alginate is 1.2% (w/v) VLVG, LVG, MVG, or SLG100. In some embodiments, the alginate is 1.3% (w/v) SLG20. In some embodiments, the alginate is 1.4% (w/v) VLVG, LVG, MVG, or SLG100. In some embodiments, the alginate is 1.5% (w/v) SLG20. In some embodiments, the alginate is 1.6% (w/v) VLVG, LVG, MVG, or SLG100. In some embodiments, the alginate is 1.7% (w/v) VLVG, LVG, MVG, or SLG100. In some embodiments, the alginate is 1.8% (w/v) SLG20. In some embodiments, the alginate is 1.9% (w/v) VLVG, LVG, MVG, or SLG100.

In some embodiments, the alginate is a hydrated alginate. In some embodiments, the alginate is hydrated in saline. In some embodiments, the alginate is hydrated in 0.9% saline (NaCl). In some embodiments, the alginate is a hydrated SLG20. In some embodiments, the alginate is a hydrated VLVG, LVG, MVG, or SLG100 alginate. In some embodiments, the alginate is hydrated in saline. In some embodiments, the alginate is hydrated in 0.9% saline (NaCl). In some embodiments, the alginate is hydrated in an aqueous solution. In some embodiments, the aqueous solution is water without any additional salts or excipients. In some embodiments, the alginate is hydrated with water.

A material within an encapsulated cell may be further modified, for example, with a chemical modification. For example, a material may be coated or derivatized with a chemical modification that provides a specific feature, such as an immunomodulatory or antifibrotic feature. Exemplary chemical modifications include small molecules, peptides, proteins, nucleic acids, lipids, or oligosaccharides. The encapsulated cell may comprise at least 0.5%, 1%, 2%, 3%, 4%, 5%, 7.5%, 10%, 15%, 20%, 30%, 40%, 50%, 60%, 70%, 80% or more of a material that is chemically modified, e.g., with a chemical modification described herein.

### B. Cells

The encapsulated cells described herein may contain a cell, for example, an engineered cell. A cell be derived from any mammalian organ or tissue, including the brain, nerves, ganglia, spine, eye, heart, liver, kidney, lung, spleen, bone, thymus, lymphatic system, skin, muscle, pancreas, stomach, intestine, blood, ovary, uterus, or testes.

A cell may be derived from a donor (e.g., an allogeneic cell), derived from a subject (e.g., an autologous cell), or from another species (e.g., a xenogeneic cell). In an embodiment, a cell can be grown in cell culture, or prepared from an established cell culture line, or derived from a donor (e.g., a living donor or a cadaver). In an embodiment, a cell is genetically engineered. In another embodiment, a cell is not genetically engineered. A cell may include a stem cell, such as a reprogrammed stem cell, or an induced pluripotent cell. Exemplary cells include mesenchymal stem cells (MSCs), fibroblasts (e.g., primary fibroblasts), HEK cells (e.g., HEK293T), Jurkat cells, HeLa cells, retinal pigment epithelial (RPE) cells, HUVEC cells, NIH3T3 cells, CHO-KI cells, COS-1 cells, COS-7 cells, PC-3 cells, HCT 116 cells, A549MCF-7 cells, HuH-7 cells, U-2 OS cells, HepG2 cells, Neuro-2a cells, and SF9 cells. In an embodiment, a cell for use in an encapsulated cell is an RPE cell.

The cells can be any type of cell. In some embodiments, the cell is a mammalian cell. In some embodiments, the cell is an epithelial cell. In some embodiments, the cell is a RPE cell. In some embodiments, the cell is a ARPE-19 cell, ARPE-19-SEAP-2-neo cell, RPE-J cell, and hTERT RPE-1 cell. In some embodiments, the cell is an engineered RPE cell. In some embodiments, the engineered cell is derived from the ARPE-19 cell line. In some embodiments, the cell is as provided herein.

A cell included in an encapsulated cell may produce or secrete antigen molecule and/or an immune effector molecule. In some embodiments, a cell included in an encapsulated cell may produce or secrete a single type of antigen molecule or a plurality of antigen molecules. In some embodiments, a cell included in an encapsulated cell may produce or secrete a single type of immune effector molecule or a plurality of immune effector molecule. In some embodiments, an encapsulated cell may comprise a cell that is transduced or transfected with a nucleic acid (e.g., a vector) comprising an expression sequence of an antigen molecule or an immune effector molecule. For example, a cell may be transduced or transfected with a lentivirus. A nucleic acid introduced into a cell (e.g., by transduction or transfection) may be incorporated into a nucleic acid delivery system, such as a plasmid, or may be delivered directly. In some embodiments, a nucleic acid introduced into a cell (e.g., as part of a plasmid) may include a region to enhance expression of the antigen molecule or immune effector molecule and/or to direct targeting or secretion, for example, a promoter sequence, an activator sequence, or a cell-signaling peptide, or a cell export peptide. Exemplary promoters include EF-1a, CMV, Ubc, hPGK, VMD2, and CAG. Exemplary activators include the TETl catalytic domain, P300 core, VPR, rTETR, Cas9 (e.g., from S. pyogenes or S. aureus), and Cpfl (e.g., from L. bacterium).

An encapsulated cell described herein may comprise a cell or a plurality of cells. In the case of a plurality of cells, the concentration and total cell number may be varied depending on a number of factors, such as cell type, implantation location, and expected lifetime of the encapsulated cell. In some embodiments, the total number of cells included in a population of encapsulated cells is greater than about 2, 4, 6, 8, 10, 20, 30, 40, 50, 75, 100, 200, 250, 500, 750, 1000, 1500, 2000, 5000, 10000, or more. In some embodiments, the total number of cells included in a population of encapsulated cells is greater than about 1.0×10², 1.0×10³, 1.0×10⁴, 1.0×10⁵, 1.0×10⁶, 1.0×10⁷, 1.0×10⁸, 1.0×10⁹, 1.0×10¹⁰, or more. In some embodiments, the total number of cells included in a population of encapsulated cells is less than about than about 10000, 5000, 2500, 2000, 1500, 1000, 750, 500, 250, 200, 100, 75, 50, 40, 30, 20, 10, 8, 6, 4, 2, or less. In some embodiments, the total number of cells included in a population of encapsulated cell is less than about 1.0×10¹⁰, 1.0×10⁹, 1.0×10⁸, 1.0×10⁷, 1.0×10⁶, 1.0×10⁵, 1.0×10⁴, 1.0×10³, 1.0×10², or less. In some embodiments, a plurality of cells is present as an aggregate. In some embodiments, a plurality of cells is present as a cell dispersion.

Specific features of a cell contained within an encapsulated cell may be determined, e.g., prior to and/or after incorporation into the encapsulated cell. For example, cell viability, cell density, or cell expression level may be assessed. In an embodiment, cell viability, cell density, and cell expression level may be determined using standard techniques, such as cell microscopy, fluorescence microscopy, histology, or biochemical assay.

### C. Antigen Molecules and Immune Effector Molecules

The methods and compositions described herein comprise populations of encapsulated cells that contain either an antigen molecule, an immune effector cell, or both. In some embodiments, the antigen molecule or immune effector molecule is produced (e.g., expressed or secreted) by a cell. The cell can be within or admixed within population of encapsulated cells, such as admixed or encapsulated by a polymer as provided for herein. In some embodiments, the polymer is an alginate, such as, but not limited to, those described herein. In some embodiments, the alginate is SLG20.

An antigen molecule provided in the encapsulated cell described herein may include a nucleic acid (e.g., an RNA, a DNA, or an oligonucleotide), a protein (e.g., an antibody, antibody fragment, enzyme, cytokine, hormone, receptor), a lipid, a small molecule, a metabolic agent, an oligosaccharide, a peptide, or an amino acid. In some embodiments, the encapsulated cell comprises a cell or a plurality of cells that are genetically engineered to produce (e.g., express or secrete) an antigen molecule. In some embodiments, the molecule is a cytokine. In some embodiments, the cytokine is IL-2 or IL-12 (IL-12a and/or IL-12b). These can be co-expressed with an antigen from the encapsulated cells, which can be the same or different as provided for herein, to enhance an immune response against the antigen. In some embodiments, the antigen is a tumor antigen.

The antigen molecule may comprise a molecule present on the surface of a pathogen or cell. For example, the antigen molecule may comprise a cell surface molecule (e.g., a glycoprotein). In some embodiments, the antigen is capable of binding to an antigen-specific antibody or B-cell antigen receptor. An antigen may be an exogenous antigen, endogenous antigen, autoantigen, neoantigen, viral antigen, or tumor antigen. In some embodiments, the antigen is a tumor antigen. In some embodiment, the antigen is a melanoma antigen or a pancreatic tumor antigen.

In some embodiments, the antigen molecule is a peptide. The peptide may comprise two or more amino acid residues, e.g., at least 2, 3, 4, 5, 6, 7, 8, 9, 10, 11, 12, 13, 14, 15, 16, 17, 18, 19, 20, 22, 24, 26, 28, 30, 32, 34, 36, 38, 40, 42, 44, 46, 48, or 50 amino acid residues. In some embodiments, the peptide is a linear peptide or a cyclic peptide. In some embodiments, the peptide may be modified, e.g., by glycosylation, methylation, or other known natural or synthetic modification. A peptide may be produced or secreted as a pre-peptide or in an inactive form and may require further modification to convert it into an active form.

In some embodiments, the antigen molecule is a protein. The protein may be of any size, e.g., greater than about 100 Da, 200 Da, 250 Da, 500 Da, 750 Da, 1 KDa, 1.5 kDa, 2 kDa, 2.5 kDa, 3 kDa, 4 kDa, 5 kDa, 6 kDa, 7 kDa, 8 kDa, 9 kDa, 10 kDa, 15 kDa, 20 kDa, 25 kDa, kDa, 35 kDa, 40 kDa, 45 kDa, 50 kDa, 55 kDa, 60 kDa, 65 kDa, 70 kDa, 75 kDa, 80 kDa, 85 kDa, 90 kDa, 95 kDa, 100 kDa, 125 kDa, 150 kDa, 200 kDa, 200 kDa, 250 kDa, 300 kDa, 400 kDa, 500 kDa, 600 kDa, 700 kDa, 800 Da, 900 kDa, or more. In some embodiments, the protein is composed of a single subunit or multiple subunits (e.g., a dimer, trimer, tetramer, etc.). A protein antigen produced or secreted by a cell may be modified, for example, by glycosylation, methylation, or other known natural or synthetic protein modification. A protein antigen may be produced or secreted as a pre-protein or in an inactive form and may require further modification to convert it into an active form.

Proteins produced or secreted by a cell may be include antibodies or antibody fragments, for example, an Fc region or variable region of an antibody. Exemplary antibodies include anti-PD-1, anti-PD-L1, anti-CTLA4, anti-TNFα, and anti-VEGF antibodies. An antibody may be monoclonal or polyclonal. Other exemplary proteins include a lipoprotein, an adhesion protein, blood clotting factor (e.g., Factor VII, Factor VIII, Factor IX, GCG, or VWF), hemoglobin, enzymes, proenkephalin, a growth factor (e.g., EGF, IGF-1, VEGF alpha, HGF, TGF beta, bFGF), or a cytokine.

An antigen molecule described herein may include a hormone. Exemplary hormones include growth hormone, growth hormone releasing hormone, prolactin, luteinizing hormone (LH), anti-diuretic hormone (ADH), oxytocin, thyroid stimulating hormone (TSH), thyrotropin-release hormone (TRH), adrenocorticotropic hormone (ACTH), follicle-stimulating hormone (FSH), thyroxine, calcitonin, parathyroid hormone, aldosterone, cortisol, epinephrine, glucagon, insulin, estrogen, progesterone, and testosterone.

An antigen molecule described herein may be a viral antigen. In some embodiments, a viral antigen is any molecule derived from a virus, such a capsid protein, a spike protein, or a fragment thereof. Exemplary viral antigens may be derived from a viral family including Arenaviridae, Arterivirus, Astroviridae, Baculoviridae, Badnavirus, Barnaviridae, Birnaviridae, Bromoviridae, Bunyaviridae, Caliciviridae, Capillovirus, Carlavirus, Caulimovirus, Circoviridae, Closterovirus, Comoviridae, Coronaviridae, Corticoviridae, Cystoviridae, Deltavirus, Dianthovirus, Enamovirus, Filoviridae Flaviviridae, Hepadnaviridae, Herpesviridae, Hypoviridae, Iridoviridae, Leviviridae, Lipothrixviridae, Microviridae, Orthomyxoviridae, Papovaviridae, Paramyxoviridae, Parvoviridae, Picornaviridae, Poxviridae, Reoviridae, Retroviridae, Rhabdoviridae, Togaviridae, and Totiviridae. A viral antigen described herein may be derived from marburg virus, ebola virus, dengue virus, rabies virus, rotavirus, rubella virus, measles virus, respiratory syncytial virus, hepatitis A virus, hepatitis B virus, hepatitis C virus, hepatitis D virus, herpes virus, human immunodeficiency virus (HIV), rhinovirus, vaccinia virus, norovirus, Epstein-Barr virus, Rift Valley fever virus, West Nile virus, Hantaa virus, human papillomavirus, smallpox virus, poliovirus, rhinovirus, hepatovirus, aphthovirus, measles, mumps, influenza, Norwalk virus, Zika virus, Japanese encephalitis virus, yellow fever virus, simian foamy virus, western equine encephalitis virus, variola virus, severe acute respiratory syndrome coronavirus (SARS CoV), severe acute respiratory syndrome coronavirus 2 (SARS CoV-2), Middle East respiratory syndrome virus, or any strain thereof. In an embodiment, the viral antigen is derived from severe acute respiratory syndrome coronavirus 2 (SARS CoV-2).

An antigen molecule described herein may be a bacterial antigen. In some embodiments, a bacterial antigen is any molecule derived from a bacterium, such lipopolysaccharide, endotoxin, a bacterial protein, or a fragment thereof. Exemplary bacterial antigens may be derived from a bacterial family including Actinomyces, Anabaena, Bacillus, Bacteroides, Bdellovibrio, Bordetella, Borrelia, Campylobacter, Caulobacter, Chlamydia, Chlorobium, Chromatium, Clostridium, Corynebacterium, Cytophaga, Deinococcus, Escherichia, Francisella, Halobacterium, Heliobacter, Haemophilus, Hemophilus, Hyphomicrobium, Legionella, Leptspirosis, Listeria, Meningococcus, Methanobacterium, Micrococcus, Myobacterium, Mycoplasma, Myxococcus, Neisseria, Nitrobacter, Oscillatoria, Prochloron, Proteus, Pseudomonas, Phodospirillum, Rickettsia, Salmonella, Shigella, Spirillum, Spirochaeta, Staphylococcus, Streptococcus, Streptomyces, Sulfolobus, Thermoplasma, Thiobacillus, and Treponema, Vibrio, and Yersinia.

An antigen molecule described herein may be a tumor antigen. In some embodiments, a tumor antigen is a molecule present on or in the surface of a tumor cell. A tumor antigen may differ from a non-antigen present in a subject by a single point mutation or several mutations (e.g., a tumor-specific antigen). Exemplary tumor antigens include alpha-actinin-4, Bcr-Abl, Casp-8, beta-catenin, cdc27, cdk4, cdkn2a, coa-1, EF2, ETV6-AML1 fusion protein, LDLR-fucosyltransferaseAS fusion protein, HLA-A2, HLA-A11, hsp70-2, KIAA0205, Mart2, Mum-1, 2, and 3, neo-PAP, myosin class I, OS-9, pml-RARa fusion protein, PTPRK, K-ras, N-ras, Triosephosphate isomerase, Bage-1, Gage 3,4,5,6,7, GnTV, Herv-K-mel, Lage-1, Mage-A1,2,3,4,6,10,12, Mage-C2, NA-88,NY-Eso-1/Lage-2, SP17, SSX-2, andTRP2-Int2, MelanA (MART-I), gp100 (Pmel 17), tyrosinase, TRP-1, TRP-2, MAGE-1, MAGE-3, BAGE, GAGE-1, GAGE-2, p15(58), CEA, RAGE, NY-ESO (LAGE), SCP-1, Hom/Mel-40, PRAME, p53, H-Ras, HER-2/neu, BCR-ABL, E2A-PRL, H4-RET, IGH-IGK, MYL-RAR, Epstein Barr virus antigens, EBNA, human papillomavirus (HPV) antigens E6 and E7, TSP-180, MAGE-4, MAGE-5, MAGE-6, p185erbB2, pi80erbB-3, c-met, nm-23H1, PSA, TAG-72-4, CA 19-9, CA 72-4, CAM 17.1, NuMa, K-ras, b-Catenin, CDK4, Mum-1, p16, TAGE, PSMA, PSCA, CT7, telomerase, 43-9F, 5T4, 791Tgp72, a-fetoprotein, 13HCG, BCA225, BTAA, CA 125, CA 15-3 (CA 27.29\BCAA), CA 195, CA 242, CA-50, CAM43, CD68KP1, CO-029, FGF-5, G250, Ga733 (EpCAM), HTgp-175, M344, MA-50, MG7-Ag, MOV18, NB70K, NY-CO-1, RCAS1, SDCCAG16, TA-90 (Mac-2 binding proteincyclophilin C-associated protein), TAAL6, TAG72, TLP, and TPS, or a fragment thereof. A tumor antigen may be associated with any cancer, for example, a cancer described herein.

An antigen molecule described herein may be selected using an antigen selection technique, e.g., an in silico antigen selection process. For example, an antigen described herein may be selected using an automated or semi-automated in silico process for identifying tumor antigens from tumor mutation and expression data, e.g., to identify antigens predicted to bind and be presented by HLA class I molecules and elicit anti-tumor T cell immunity, e.g., in a subject. In some embodiments, the in silico antigen selection process involves the analysis of massively parallel DNA and RNA sequencing data, to systematically identify and shortlist candidate antigen peptides from a tumor's mutational repertoire that could potentially be used in a vaccine.

In some embodiments, the in silico antigen selection process involves the steps of: obtaining a list of non-synonymous mutations identified by a somatic variant-calling pipeline, using exomic sequencing and transcript sequencing of both normal and tumor tissue; and annotating the list with amino acid changes (e.g., amino acid changes arising from a missense mutation) and transcript sequences. Amino acid FASTA sequences comprising mutated and wild-type sequences (e.g., 17-21-mer sequences) may then be built and input into the in silico process, together with HLA haplotype data, e.g., obtained from the subject to be treated, provided by using clinical genotyping assays or in silico approaches. Subsequent analysis in silico can perform epitope prediction, integrate sequencing-based information, and filter antigen candidates (e.g., limiting to peptide sequences predicted to have the strongest binding (e.g., a mutant (MT) binding score of less than 500 nM, e.g., less than 250 nM); eliminating wild-type (WT) peptides; and/or limiting to peptides that are expressed as an RNA variant), thereby identifying tumor antigens predicted to bind and be presented by HLA class I molecules and elicit anti-tumor T cell immunity.

In some embodiments, the antigen molecule is selected using a personalized Variant Antigens by Cancer Sequencing (pVAC-Seq) method. In some embodiments, the antigen molecule is selected using a method described in Hundal, et al. (Genome Med. (2016) 8:11) or Carreno et al (U.S. Patent Publication No. 2017/0202939), each of which are incorporated herein by reference in their entirety. Antigens selected by an antigen selection technique may be further validated using biochemical or cellular assays, and/or incorporated into a vaccine or formulation thereof, using known methods, e.g., as described by Carreno (vide supra).

An antigen molecule described herein may be an autoantigen. In some embodiments, an autoantigen is a protein or nucleic acid derived from a subject that is recognized by the immune system of the subject. In some embodiments, the autoantigen is a self-antigen. In some embodiments, the autoantigen is not tissue specific. In some embodiments, the autoantigen is a tRNA synthetase. Exemplary autoantigens are those that are associated with a disease including celiac disease, lupus erythematosus, rheumatoid arthritis, dermatomyostis, scleroderma, sarcoidosis, vitiligo, multiple sclerosis, gluten ataxia, autoimmune encephalitis, idiopathic thrombocytopenic purpura, Crohn's disease, Hashimoto's thyroiditis, Addison's disease, diabetes mellitus type 1, pemphigus vulgaris, pernicious vulgaris, and autoimmune hemolytic anemia. In some embodiments, an autoantigen is capable of recognition by an autoantibody.

An antigen molecule described herein may be an allergen, such an environmental allergen. For example, an antigen may be a molecule produced by a non-host cell, such as a plant, bacterial, fungal, or insect cell. An allergen may be a pollen allergen (e.g., from a tree or grass), an animal allergen (e.g., animal hair or dander), insect allergen (e.g., venom), food allergen (e.g., peanut allergen, wheat allergen, gluten allergen) or a fragment thereof. The allergen may be naturally occurring or produced by humans, e.g., a detergent, household chemical, pesticide, dye, or pharmaceutical.

In some embodiments, an encapsulated cell comprises a cell expressing a single type of antigen molecule or may express more than one type of antigen molecule, e.g., a plurality of antigen molecules. In some embodiments, an encapsulated cell comprises a cell expressing two types of antigen molecules. In some embodiments, an encapsulated cell comprises a cell expressing three types of antigen molecules. In some embodiments, an encapsulated cell comprises a cell expressing four types of antigen molecules.

The immune effector cell described herein may activate an immune cell, repress an immune cell, and/or modulates (e.g., initiate) immune cell migration, e.g., in a subject. In some embodiments, the immune effector molecule modulates host dendritic cell migration or host cell T activation.

An immune effector molecule provided in the encapsulated cells described herein may include a cytokine. A cytokine may be a pro-inflammatory cytokine, an anti-inflammatory cytokine, or a chemokine (e.g., which may initiate immune cell migration). Example of cytokines include IL-1, IL-1α, IL-1β, IL-iRA, IL-2, IL-4, IL-5, IL-6, IL-7, IL-8, IL-9, IL-1β, IL-11, IL-12, IL-12a, IL-12b, IL-13, IL-14, IL-16, IL-17, G-CSF, GM-CSF, IL-20, IFN-α, IFN-β, IFN-γ, CD154, LT-0, CD70, CD153, CD178, TRAIL, TNF-α, TNF-β, SCF, M-CSF, MSP, 4-1BBL, LIF, OSM, and others. For example, a cytokine may include any cytokine described in M. J. Cameron and D. J. Kelvin, Cytokines, Chemokines, and Their Receptors (2013), Landes Biosciences, which is incorporated herein by reference in its entirety.

In some embodiments, the immune effector molecule (e.g., a cytokine) is a protein. The immune effector molecule (e.g., cytokine) may be of any size, e.g., greater than about 50 Da, 100 Da, 200 Da, 250 Da, 500 Da, 750 Da, 1 KDa, 1.5 kDa, 2 kDa, 2.5 kDa, 3 kDa, 4 kDa, 5 kDa, 6 kDa, 7 kDa, 8 kDa, 9 kDa, 10 kDa, 15 kDa, 20 kDa, 25 kDa, 30 kDa, 35 kDa, 40 kDa, kDa, 50 kDa, 55 kDa, 60 kDa, 65 kDa, 70 kDa, 75 kDa, 80 kDa, 85 kDa, 90 kDa, 95 kDa, 100 kDa, 125 kDa, 150 kDa, 200 kDa, 200 kDa, 250 kDa, 300 kDa, 400 kDa, 500 kDa, 600 kDa, 700 kDa, 800 Da, 900 kDa, or more. In some embodiments, the immune effector molecule (e.g., cytokine) is composed of a single subunit or multiple subunits (e.g., a dimer, trimer, tetramer, etc.). An immune effector molecule produced or secreted by a cell may be modified, for example, by glycosylation, methylation, or other known natural or synthetic protein modification. A immune effector molecule may be produced or secreted as a pre-protein or in an inactive form and may require further modification to convert it into an active form.

An encapsulated cell may comprise a cell expressing a single type of immune effector molecule (e.g., single type of cytokine), or may express more than one type of immune effector molecule (e.g., a plurality of cytokines). In some embodiments, an encapsulated cell comprises a cell expressing two types of immune effector molecules (e.g., two types of cytokines). In some embodiments, an encapsulated cell comprises a cell expressing three types of immune effector molecules (e.g., three types of cytokines). In some embodiments, an encapsulated cell comprises a cell expressing four types of immune effector molecules (e.g., four types of cytokines).

### D. Features of Encapsulated Cells

The population of encapsulated cells described herein may take any suitable shape or morphology. For example, the population of encapsulated cells may be a sphere, spheroid, tube, cord, string, ellipsoid, disk, cylinder, sheet, torus, cube, stadiumoid, cone, pyramid, triangle, rectangle, square, or rod. The population of encapsulated cells may comprise a curved or flat section. In some embodiments, the population of encapsulated cells may be prepared through the use of a mold, resulting in a custom shape.

The population of encapsulated cells may vary in size, depending, for example, on the use or site of implantation. For example, the population of encapsulated cells may have a mean diameter or size greater than 0.1 mm, e.g., greater than 0.25 mm, 0.5 mm, 0.75, 1 mm, 1.5 mm, 2 mm, 3 mm, 4 mm, 5 mm, 6 mm, 7 mm, 8 mm, 9 mm, 10 mm, 20 mm, 30 mm, 40 mm, 50 mm, or more. In some embodiments, the population of encapsulated cells may have a section or region with a mean diameter or size greater than 0.1 mm, e.g., greater than 0.25 mm, 0.5 mm, 0.75, 1 mm, 1.5 mm, 2 mm, 3 mm, 4 mm, 5 mm, 6 mm, 7 mm, 8 mm, 9 mm, 10 mm, 20 mm, 30 mm, 40 mm, 50 mm, or more. In some embodiments, the population of encapsulated cells may have a mean diameter or size less than 1 cm, e.g., less 50 mm, 40 mm, 30 mm, 20 mm, 10 mm, 7.5 mm, 5 mm, 2.5 mm, 1 mm, 0.5 mm, or smaller. In some embodiments, the population of encapsulated cells may have a section or region with a mean diameter or size less than 1 cm, e.g., less 50 mm, 40 mm, 30 mm, 20 mm, 10 mm, 7.5 mm, 5 mm, 2.5 mm, 1 mm, 0.5 mm, or smaller.

The encapsulated cell comprises at least one zone, which can be capable of preventing exposure of an enclosed antigen molecule or immune effector molecule from the outside milieu, e.g., a host effector cell or tissue. In some embodiments, the encapsulated cell comprises a layer or zone encapsulating or is admixed with the antigen molecule or immune effector molecule. In some embodiments, the encapsulated cell comprises an inner zone (IZ). In some embodiments, the encapsulated cell comprises an outer zone (OZ). In some embodiments, either the inner zone (IZ) or outer zone (OZ) may be erodible or degradable. In some embodiments, either the inner zone (IZ) or outer zone (OZ) is not erodible or degradable. In some embodiments, the inner zone (IZ) is erodible or degradable. In some embodiments, the inner zone (IZ) is not readily erodible or degradable. In some embodiments, the outer zone (OZ) is erodible or degradable. In some embodiments, the outer zone (OZ) is not readily erodible or degradable. In some embodiments, the encapsulated cell comprises both an inner zone (IZ) and an outer zone (OZ), either of which may be erodible or degradable. In some embodiments, the encapsulated cell comprises both an inner zone (IZ) and an outer zone (OZ), wherein the outer zone is erodible or degradable. In some embodiments, the encapsulated cell comprises both an inner zone (IZ) and an outer zone (OZ), wherein the inner zone is erodible or degradable. The thickness of either of the zone, e.g., either the inner zone or outer zone, may be correlated with the length or duration of a “shielded” phase, in which the encapsulated antigen molecule or immune effector molecule is protected or shielded from the outside milieu, e.g., a host effector cell or tissue. In some embodiments, the encapsulated cell comprises a single layer or zone that encapsulates or is admixed with the cell or other molecules provided for herein.

The zone (e.g., layer, the inner zone or outer zone) of the encapsulated cell may comprise a degradable entity, e.g., an entity capable of degradation. A degradable entity may comprise an enzyme cleavage site, a photolabile site, a pH-sensitive site, or other labile region that can be eroded or comprised over time. In some embodiments, the degradable entity is preferentially degraded upon exposure to a first condition (e.g., exposure to a first milieu, e.g., a first pH or first enzyme) relative to a second condition (e.g., exposure to a second milieu, e.g., a second pH or second enzyme). In some embodiments, the degradable entity is degraded at least 2, 5, 10, 20, 30, 40, 50, 60, 70, 80, or 100 times faster upon exposure to a first condition relative to a second condition. In some embodiments, the degradable entity is an enzyme cleavage site, e.g., a proteolytic site. In some embodiments, the degradable entity is a polymer (e.g., a synthetic polymer or a naturally occurring polymer, e.g., a peptide or polysaccharide). In some embodiments, the degradable entity is a substrate for an endogenous host component, e.g., a degradative enzyme, e.g., a remodeling enzyme, e.g., a collagenase or metalloprotease. In some embodiments, the degradable entity comprises a cleavable linker or cleavable segment embedded in a polymer.

In some embodiments, an encapsulated cell comprises a pore or opening to permit passage of an object, such as a small molecule (e.g., nutrients or waste), a protein, or a nucleic acid. For example, a pore in or on an encapsulated cell may be greater than 0.1 nm and less than 10 μm. In some embodiments, the encapsulated cell comprises a pore or opening with a size range of 0.1 μm to 10 μm, 0.1 μm to 9 μm, 0.1 μm to 8 μm, 0.1 μm to 7 μm, 0.1 μm to 6 μm, 0.1 μm to 5 μm, 0.1 μm to 4 μm, 0.1 μm to 3 μm, 0.1 μm to 2 μm. In some embodiments, the pore size is about 5 to about 50 nm. In some embodiments, the pore size is about 5 to about nm. In some embodiments, the pore size is about 5 to about 20 nm. In some embodiments, the pore size is about 5 to about 30 nm. In some embodiments, the pore size is about 5 to about nm. In some embodiments, the pore size is about 10 to about 50 nm. In some embodiments, the pore size is about 10 to about 40 nm. In some embodiments, the pore size is about 10 to about 30 nm. In some embodiments, the pore size is about 10 to about 20 nm. In some embodiments, the pore size is about 20 to about 50 nm. In some embodiments, the pore size is about 20 to about 40 nm. In some embodiments, the pore size is about 20 to about 30 nm. In some embodiments, the pore size is about 30 to about 50 nm. In some embodiments, the pore size is about 30 to about 40 nm. In some embodiments, the pore size is about 40 to about 50 nm.

An encapsulated cell described herein may comprise a chemical modification in or on any enclosed material. Exemplary chemical modifications include small molecules, peptides, proteins, nucleic acids, lipids, or oligosaccharides. The encapsulated cell may comprise at least 0.5%, 1%, 2%, 3%, 4%, 5%, 7.5%, 10%, 15%, 20%, 30%, 40%, 50%, 60%, 70%, 80% or more of a material that is chemically modified, e.g., with a chemical modification described herein. An encapsulated cell may be partially coated with a chemical modification, e.g., at least about 5%, 10%, 15%, 20%, 25%, 30%, 35%, 40%, 45%, 50%, 55%, 60%, 65%, 70%, 75%, 80%, 85%, 90%, 95%, 99%, or 99.9% coated with a chemical modification.

In some embodiments, the capsule has a diameter of about 1 to about 2 mm, about 1 mm, about 1.5 mm, or about 2 mm.

In some embodiments, the encapsulated cell is formulated such that the duration of release of the antigen molecule and/or immune effector molecule is tunable. For example, an encapsulated cell may be configured in a certain manner to release a specific amount of an antigen molecule and/or immune effector molecule over time, e.g., in a sustained or controlled manner. In some embodiments, the encapsulated cell comprises a zone (e.g., an inner zone or an outer zone) that is degradable, and this controls the duration of release from the construct by gradually ceasing immunoprotection of encapsulated cells or causing gradual release of the antigen molecule and/or immune effector molecule. In some embodiments, the encapsulated cell is configured such that the level of release of an antigen molecule and/or immune effector molecule is sufficient to modulate the ratio of a host effector cell, e.g., a host T cell. In some embodiments, the encapsulated cell is configured such that the level of release of an antigen molecule and/or immune effector molecule is sufficient to activate a host cell (e.g., a host T effector cell or a host NK cell) or increase the level of certain host cells (e.g., host T effector cells or host NK cells). In some embodiments, the encapsulated cell is configured such that the level of release of an antigen molecule and/or immune effector molecule is not sufficient to activate a host regulator cell (e.g., a host T regulator cell) or increase the level of host regulator cells (e.g., host T regulator cells).

In some embodiments, the encapsulated cell comprises a zone that is targeted by the natural foreign body response (FBR) of a host or subject, e.g., over a period of time. In some embodiments, the encapsulated cell is coated with fibrotic overgrowth upon administration to a subject, e.g., over a period of time. Fibrotic overgrowth on the surface of the encapsulated cell may lead to a decrease in function of the encapsulated cell. For example, a decrease in function may comprise a reduction in the release of an antigenic or therapeutic agent over time, a decrease in pore size, or a decrease in the diffusion rate of oxygen and other key nutrients to the encapsulated cells, leading to cell death. In some embodiments, the rate of fibrotic overgrowth may be tuned to design a dosing regimen. For example, the fibrotic overgrowth on the surface of an encapsulated cell may result in a decrease in function of the encapsulated cell about 6 hours, 12 hours, 18 hours, 1 day, 2 days, 3 days, 4 days, 5 days, 6 days, 7 days, 8 days, 9 days, 10 days, 11 days, 12 days, 13 days, 2 weeks, 2.5 weeks, 3 weeks, 4 weeks, or 6 weeks after administration (e.g., injection or implantation) to a subject.

In some embodiments, the encapsulated cell is chemically modified with a specific density of modifications. The specific density of chemical modifications may be described as the average number of attached chemical modifications per given area. For example, the density of a chemical modification on or in an encapsulated cell may be 0.01, 0.1, 0.5, 1, 5, 10, 15, 20, 50, 75, 100, 200, 400, 500, 750, 1,000, 2,500, or 5,000 chemical modifications per square μm or square mm.

A population of encapsulated cells may be formulated or configured for implantation in any organ, tissue, cell, or part of a subject. For example, the population of encapsulated cells may be implanted or disposed into the intraperitoneal space of a subject. A population of encapsulated cells may be implanted in or disposed on a tumor or other growth in a subject, or be implanted in or disposed about 0.1 mm, 0.5 mm, 1 mm, 0.25 mm, 0.5 mm, 0.75, 1 mm, 1.5 mm, 2 mm, 3 mm, 4 mm, 5 mm, 6 mm, 7 mm, 8 mm, 9 mm, 10 mm, 20 mm, 30 mm, 40 mm, 50 mm, 1 cm, 5, cm, 10 cm, or further from a tumor or other growth in a subject. A population of encapsulated cells may be configured for implantation, or implanted, or disposed on or in the skin, a mucosal surface, a body cavity, the central nervous system (e.g., the brain or spinal cord), an organ (e.g., the heart, eye, liver, kidney, spleen, lung, ovary, breast, uterus), the lymphatic system, vasculature, oral cavity, nasal cavity, gastrointestinal tract, bone, muscle, adipose tissue, skin, or other area.

A population of encapsulated cells may be formulated for use for any period of time. For example, a population of encapsulated cells may be used for 1 hour, 2 hours, 4 hours, 6 hours, 12 hours, 1 day, 36 hours, 2 days, 3 days, 4 days, 5 days, 6 days, 1 week, 2 weeks, 3 weeks, 4 weeks, 5 weeks, 6 weeks, 2 months, 3 months, 4 months, 5 months, 6 months, 1 year, or longer. A population of encapsulated cells can be configured for limited exposure (e.g., less than 2 days, e.g., less than 2 days, 1 day, 24 hours, 20 hours, 16 hours, 12 hours, 10 hours, 8 hours, 6 hours, 5 hours, 4 hours, 3 hours, 2 hours, 1 hour or less). A population of encapsulated cells can be configured for prolonged exposure (e.g., at least 2 days, 3 days, 4 days, 5 days, 6 days, 7 days, 1 week, 2 weeks, 3 weeks, 4 weeks, 5 weeks, 1 month, 2 months, 3 months, 4 months, 5 months, 6 months, 7 months, 8 months, 9 months, 10 months, 11 months, 12 months, 13 months, 14 months, 15 months, 16 months, 17 months, 18 months, 19 months, 20 months, 21 months, 22 months, 23 months, 24 months, 1 year, 1.5 years, 2 years, 2.5 years, 3 years, 3.5 years, 4 years or more). A population of encapsulated cells can be configured for permanent exposure (e.g., at least 6 months, 7 months, 8 months, 9 months, 10 months, 11 months, 12 months, 13 months, 14 months, 15 months, 16 months, 17 months, 18 months, 19 months, 20 months, 21 months, 22 months, 23 months, 24 months, 1 year, 1.5 years, 2 years, 2.5 years, 3 years, 3.5 years, 4 years or more).

Other examples of encapsulated cells can be found in U.S. Publication No. 2022/0313599, U.S. Publication No. 2022/0411795, and PCT Publication No. WO2021/163242, WO2022/140195, each of which are hereby incorporated by reference in its entirety.

### E. Methods of Cryopreserving Encapsulated Cells

In some embodiments, method of cryopreserving a population of encapsulated cells is provided. In some embodiments, the method comprises the step of adding an effective amount of a cryopreservation media to the population of encapsulated cells to form a cryopreservation composition. In some embodiments, the method comprises the optional step of incubating the cryopreservation composition at room temperature prior to cooling. In some embodiments, the method comprises the step of cooling the cryopreservation composition to a temperature sufficient to cryopreserve the cells.

In some embodiments, a method of cryopreserving a population of encapsulated cells is provided, wherein the population of encapsulated cells comprises a plurality of oligonucleotide molecules encoding an antigen molecule; and the method comprises the steps of adding an effective amount of a cryopreservation media to the population of encapsulated cells to form a cryopreservation composition; optionally, incubating the cryopreservation composition at room temperature prior to cooling; and cooling the cryopreservation composition to a temperature sufficient to cryopreserve the cells.

In some embodiments, a method of cryopreserving a population of encapsulated cells is provided, wherein the population of encapsulated cells comprises a plurality of oligonucleotide molecules encoding an antigen molecule; and the method comprises the steps of adding an effective amount of a cryopreservation media to the population of encapsulated cells to form a cryopreservation composition; and cooling the cryopreservation composition to a temperature sufficient to cryopreserve the cells.

In some embodiments, a method of cryopreserving a population of encapsulated cells is provided, wherein the population of encapsulated cells comprises a plurality of oligonucleotide molecules encoding an antigen molecule; and the method comprises the steps of adding an effective amount of a cryopreservation media to the population of encapsulated cells to form a cryopreservation composition; incubating the cryopreservation composition at room temperature prior to cooling; and cooling the cryopreservation composition to a temperature sufficient to cryopreserve the cells.

The cells can be any type of cell. In some embodiments, the cell is a mammalian cell. In some embodiments, the cell is an epithelial cell. In some embodiments, the cell is a RPE cell. In some embodiments, the cell is a ARPE-19 cell, ARPE-19-SEAP-2-neo cell, RPE-J cell, and hTERT RPE-1 cell. In some embodiments, the cell is an engineered RPE cell. In some embodiments, the engineered cell is derived from the ARPE-19 cell line. In some embodiments, the cell is as provided herein. In some embodiments, the surfactant is TWEEN (polysorbate 20). In some embodiments, the buffer is HEPES buffer. In some embodiments, the sugar alcohol is mannitol. In some embodiments, the metal salt is barium chloride.

In some embodiments, the method comprises washing the encapsulated cells produced according to the methods provided for herein in a buffer solution produced. In some embodiments, the washing step removes substantially all or all of the free barium or barium chloride.

In some embodiments, the encapsulated cells prepared according to the methods provided herein are stored in a storage buffer, such as DMEM/F12 cell culture media. In some embodiments, the stored cells retain viability for at least 5, 10, 20, or 30 days. In some embodiments, the storage buffer is substantially free of plasmalyte buffer.

Also provided for herein, are a population of encapsulated cells prepared according to a method as provided for herein.

In some embodiments, a suspension of encapsulated cells is provided. In some embodiments, the suspension comprises a population of encapsulated cells as provided for herein. In some embodiments, the encapsulated cells are encapsulated by a polymeric hydrogel, and the suspension comprises a crosslinking solution that comprises a sugar alcohol, a buffer, a metal salt (e.g. divalent cation), and a surfactant. In some embodiments, the cells are ARPE-19 cells. In some embodiments, the surfactant is TWEEN 20 (polysorbate 20). In some embodiments, the buffer is HEPES buffer. In some embodiments, the sugar alcohol is mannitol. In some embodiments, the metal salt is barium salt (e.g. barium chloride and the like), a calcium salt (e.g. calcium chloride and the like) or strontium salt (e.g. strontium chloride and the like).

In some embodiments, suspensions of encapsulated cells are provided, wherein the suspension comprises a population of encapsulated cells as provided for herein, wherein the encapsulated cells are encapsulated by a polymeric hydrogel, and a storage buffer, such as DMEM/F12 cell culture media. In some embodiments, the storage buffer is a buffer that has a physiological osmolality and a pH, such as a pH from about 6.5 to about 7.5.

In some embodiments, the methods comprise contacting the encapsulated cells in a container with an effective amount of a cryopreservation media to form cryopreservation composition, wherein the cryopreservation media comprises at least 5-12% dimethylsulfoxide (DMSO) and at least one other component; incubating the container comprising the cryopreservation composition at room temperature (e.g. 20-25° C.); and cooling the incubated container comprising the cryopreservation composition at rate of 1-5° C. to a temperature sufficient to cryopreserve the encapsulated cells. In some embodiments, the at least one other component is polyethylene glycol or propylene glycol.

In some embodiments, the suspension provided for herein are substantially free of plasmalyte buffer. In some embodiments, the suspension provided for herein are comprise plasmalyte buffer.

In some embodiments, the cryopreservation media is selected from BAMBANKER™, CryoStor® CS10, CryoStor® CS5, CTS™ Synth-a-Freeze™, glycerol, propylene glycol (PG), ethylene glycol (EG), dimethyl sulfoxide (DMSO), and/or polyethylene glycol (PEG). In some embodiments, the cryopreservation media is BAMBANKER™. In some embodiments, the cryopreservation media is CryoStor® CS10. In some embodiments, the cryopreservation media is CryoStor® CS5. In some embodiments, the cryopreservation media is CTS™ Synth-a-Freeze™. In some embodiments, the cryopreservation media is glycerol. In some embodiments, the cryopreservation media is propylene glycol (PG). In some embodiments, the cryopreservation media is ethylene glycol (EG). In some embodiments, the cryopreservation media is dimethyl sulfoxide (DMSO). In some embodiments, the cryopreservation media is polyethylene glycol (PEG). In some embodiments, the cryopreservation media comprises BAMBANKER™, CryoStor® CS10, CryoStor® CS5, CTS™ Synth-a-Freeze™, glycerol, propylene glycol (PG), ethylene glycol (EG), dimethyl sulfoxide (DMSO), polyethylene glycol (PEG), or any combination thereof. In some embodiments, the cryopreservation media comprises propylene glycol (PG) and dimethyl sulfoxide (DMSO). In some embodiments, the cryopreservation media comprises ethylene glycol (EG) and dimethyl sulfoxide (DMSO). In some embodiments, the cryopreservation media comprises propylene glycol (PG), ethylene glycol (EG), and dimethyl sulfoxide (DMSO). In some embodiments, the media comprises human serum albumin. In some embodiments, the media is free of human serum albumin. some embodiments, the media comprises bovine serum albumin. In some embodiments, the media is free of bovine serum albumin. In some embodiments, the cryopreservation media comprises about 0.1%-99% of BAMBANKER™, BAMBANKER HRM, CryoStor® CS10, CryoStor® CS5, CTS™ Synth-a-Freeze™, glycerol, propylene glycol (PG), ethylene glycol (EG), dimethyl sulfoxide (DMSO), polyethylene glycol (PEG), or any combination thereof, in cell media. In some embodiments, the cryopreservation media comprises about 0.1%-99% of BAMBANKER™ in cell media. In some embodiments, the cryopreservation media comprises about 0.1%-99% of CryoStor® CS10 in cell media. In some embodiments, the cryopreservation media comprises about 0.1%-99% of CryoStor® CS5 in cell media. In some embodiments, the cryopreservation media comprises about 0.1%-99% of CTS™ Synth-a-Freeze™ in cell media. In some embodiments, the cryopreservation media comprises about 0.1%-99% of glycerol in cell media. In some embodiments, the cryopreservation media comprises about 0.1%-99% of propylene glycol (PG) in cell media. In some embodiments, the cryopreservation media comprises about 0.1%-99% of ethylene glycol (EG) in cell media. In some embodiments, the cryopreservation media comprises about 0.1%-99% of dimethyl sulfoxide (DMSO) in cell media. In some embodiments, the cryopreservation media comprises about 0.1%-99% of polyethylene glycol (PEG) in cell media. In some embodiments, the cryopreservation media comprises about 4%-50% of propylene glycol (PG), ethylene glycol (EG), dimethyl sulfoxide (DMSO), or any combination thereof, in cell media. In some embodiments, the cryopreservation media comprises about 4% of propylene glycol (PG), ethylene glycol (EG), dimethyl sulfoxide (DMSO), or any combination thereof, in cell media. In some embodiments, the cryopreservation media comprises about 4.4% of propylene glycol (PG), ethylene glycol (EG), dimethyl sulfoxide (DMSO), or any combination thereof, in cell media. In some embodiments, the cryopreservation media comprises about 16% of propylene glycol (PG), ethylene glycol (EG), dimethyl sulfoxide (DMSO), or any combination thereof, in cell media. In some embodiments, the cryopreservation media comprises about 22% of propylene glycol (PG), ethylene glycol (EG), dimethyl sulfoxide (DMSO), or any combination thereof, in cell media. In some embodiments, the cryopreservation media comprises about 27% of propylene glycol (PG), ethylene glycol (EG), dimethyl sulfoxide (DMSO), or any combination thereof, in cell media. In some embodiments, the cryopreservation media comprises about 44% of propylene glycol (PG), ethylene glycol (EG), dimethyl sulfoxide (DMSO), or any combination thereof, in cell media. In some embodiments, the cryopreservation media comprises about 4% of propylene glycol (PG) and dimethyl sulfoxide (DMSO) in cell media. In some embodiments, the cryopreservation media comprises about 4.4% of propylene glycol (PG) and dimethyl sulfoxide (DMSO) in cell media. In some embodiments, the cryopreservation media comprises about 16% of propylene glycol (PG) and dimethyl sulfoxide (DMSO) in cell media. In some embodiments, the cryopreservation media comprises about 22% of propylene glycol (PG) and dimethyl sulfoxide (DMSO) in cell media. In some embodiments, the cryopreservation media comprises about 27% of propylene glycol (PG) and dimethyl sulfoxide (DMSO) in cell media. In some embodiments, the cryopreservation media comprises about 44% of propylene glycol (PG) and dimethyl sulfoxide (DMSO) in cell media. In some embodiments, the cryopreservation media comprises about 4% of ethylene glycol (EG) and dimethyl sulfoxide (DMSO) in cell media. In some embodiments, the cryopreservation media comprises about 4.4% of ethylene glycol (EG) and dimethyl sulfoxide (DMSO) in cell media. In some embodiments, the cryopreservation media comprises about 16% of ethylene glycol (EG) and dimethyl sulfoxide (DMSO) in cell media. In some embodiments, the cryopreservation media comprises about 22% of ethylene glycol (EG) and dimethyl sulfoxide (DMSO) in cell media. In some embodiments, the cryopreservation media comprises about 27% of ethylene glycol (EG) and dimethyl sulfoxide (DMSO) in cell media. In some embodiments, the cryopreservation media comprises about 44% of ethylene glycol (EG) and dimethyl sulfoxide (DMSO) in cell media.

In some embodiments, the DMSO is present at a final concentration of about 5 to about 12% (v/v). In some embodiments, the DMSO is present at a final concentration of about 6 to about 12% (v/v). In some embodiments, the DMSO is present at a final concentration of about 7 to about 12% (v/v). In some embodiments, the DMSO is present at a final concentration of about 8 to about 12% (v/v). In some embodiments, the DMSO is present at a final concentration of about 9 to about 12% (v/v). In some embodiments, the DMSO is present at a final concentration of about 10 to about 12% (v/v). In some embodiments, the DMSO is present at a final concentration of 11 to about 12% (v/v). In some embodiments, the DMSO is present at a final concentration of 5 to about 11% (v/v). In some embodiments, the DMSO is present at a final concentration of 5 to about 10% (v/v). In some embodiments, the DMSO is present at a final concentration of 5 to about 9% (v/v). In some embodiments, the DMSO is present at a final concentration of 5 to about 8% (v/v). In some embodiments, the DMSO is present at a final concentration of 5 to about 7% (v/v). In some embodiments, the DMSO is present at a final concentration of 5 to about 6% (v/v). In some embodiments, the DMSO is present at a final concentration of 6 to about 11% (v/v). In some embodiments, the DMSO is present at a final concentration of 6 to about 10% (v/v). In some embodiments, the DMSO is present at a final concentration of 6 to about 9% (v/v). In some embodiments, the DMSO is present at a final concentration of 6 to about 8% (v/v). In some embodiments, the DMSO is present at a final concentration of 6 to about 7% (v/v). In some embodiments, the DMSO is present at a final concentration of 7 to about 110% (v/v). In some embodiments, the DMSO is present at a final concentration of 7 to about 10% (v/v). In some embodiments, the DMSO is present at a final concentration of 7 to about 9% (v/v). In some embodiments, the DMSO is present at a final concentration of 7 to about 8% (v/v). In some embodiments, the DMSO is present at a final concentration of 8 to about 11% (v/v). In some embodiments, the DMSO is present at a final concentration of 8 to about 10% (v/v). In some embodiments, the DMSO is present at a final concentration of 8 to about 9% (v/v). In some embodiments, the DMSO is present at a final concentration of 9 to about 11% (v/v). In some embodiments, the DMSO is present at a final concentration of 9 to about 10% (v/v). In some embodiments, the DMSO is present at a final concentration of 10 to about 11% (v/v).

In some embodiments, the media comprises about 1 to about 50% (w/v) of HSA. In some embodiments, the media comprises about 1 to about 40% (w/v) of HSA. In some embodiments, the media comprises about 1 to about 30% (w/v) of HSA. In some embodiments, the media comprises about 1 to about 20% (w/v) of HSA. In some embodiments, the media comprises about 1 to about 10% (w/v) of HSA. In some embodiments, the media comprises about 5 to about 50% (w/v) of HSA. In some embodiments, the media comprises about 5 to about 40% (w/v) of HSA. In some embodiments, the media comprises about 5 to about 30% (w/v) of HSA. In some embodiments, the media comprises about 5 to about 20% (w/v) of HSA. In some embodiments, the media comprises about 5 to about 10% (w/v) of HSA. In some embodiments, the media comprises about 10 to about 50% (w/v) of HSA. In some embodiments, the media comprises about 10 to about 40% (w/v) of HSA. In some embodiments, the media comprises about 10 to about 30% (w/v) of HSA. In some embodiments, the media comprises about 10 to about 20% (w/v) of HSA. In some embodiments, the media comprises about 20 to about 50% (w/v) of HSA. In some embodiments, the media comprises about 20 to about 40% (w/v) of HSA. In some embodiments, the media comprises about 20 to about 30% (w/v) of HSA. In some embodiments, the media comprises about 30 to about 50% (w/v) of HSA. In some embodiments, the media comprises about 30 to about 40% (w/v) of HSA. In some embodiments, the media comprises about 40 to about 50% (w/v) of HSA.

In some embodiments, the cryopreservation media comprises a sugar. In some embodiments, the sugar is trehalose, mannose, sucrose, or any combination thereof. In some embodiments, the cryopreservation media does not comprise a sugar.

In some embodiments, the cryopreservation media is added to the population of encapsulated cells at a ratio of about 50 mL, about 40 mL, about 30 mL, about 20 mL, about 10 mL, about 9 mL, about 8 mL, about 7 mL, about 8 mL, about 6 mL, about 5 mL, about 4 mL, about 3 mL, about 2 mL, about 1 mL, about 0.5 mL, or about 0.1 mL of the cryopreservation media to about 1 mL of the population of encapsulated cells. In some embodiments, the cryopreservation media is added to the population of encapsulated cells at a ratio of about 50 mL of the cryopreservation media to about 1 mL of the population of encapsulated cells. In some embodiments, the cryopreservation media is added to the population of encapsulated cells at a ratio of about 40 mL of the cryopreservation media to about 1 mL of the population of encapsulated cells. In some embodiments, the cryopreservation media is added to the population of encapsulated cells at a ratio of about 30 mL of the cryopreservation media to about 1 mL of the population of encapsulated cells. In some embodiments, the cryopreservation media is added to the population of encapsulated cells at a ratio of about 20 mL of the cryopreservation media to about 1 mL of the population of encapsulated cells. In some embodiments, the cryopreservation media is added to the population of encapsulated cells at a ratio of about 10 mL of the cryopreservation media to about 1 mL of the population of encapsulated cells. In some embodiments, the cryopreservation media is added to the population of encapsulated cells at a ratio of about 9 mL of the cryopreservation media to about 1 mL of the population of encapsulated cells. In some embodiments, the cryopreservation media is added to the population of encapsulated cells at a ratio of about 8 mL of the cryopreservation media to about 1 mL of the population of encapsulated cells. In some embodiments, the cryopreservation media is added to the population of encapsulated cells at a ratio of about 7 mL of the cryopreservation media to about 1 mL of the population of encapsulated cells. In some embodiments, the cryopreservation media is added to the population of encapsulated cells at a ratio of about 6 mL of the cryopreservation media to about 1 mL of the population of encapsulated cells. In some embodiments, the cryopreservation media is added to the population of encapsulated cells at a ratio of about 5 mL of the cryopreservation media to about 1 mL of the population of encapsulated cells. In some embodiments, the cryopreservation media is added to the population of encapsulated cells at a ratio of about 4 mL of the cryopreservation media to about 1 mL of the population of encapsulated cells. In some embodiments, the cryopreservation media is added to the population of encapsulated cells at a ratio of about 3 mL of the cryopreservation media to about 1 mL of the population of encapsulated cells. In some embodiments, the cryopreservation media is added to the population of encapsulated cells at a ratio of about 2 mL of the cryopreservation media to about 1 mL of the population of encapsulated cells. In some embodiments, the cryopreservation media is added to the population of encapsulated cells at a ratio of about 1 mL of the cryopreservation media to about 1 mL of the population of encapsulated cells. In some embodiments, the cryopreservation media is added to the population of encapsulated cells at a ratio of about 0.5 mL of the cryopreservation media to about 1 mL of the population of encapsulated cells. In some embodiments, the cryopreservation media is added to the population of encapsulated cells at a ratio of about 0.1 mL of the cryopreservation media to about 1 mL of the population of encapsulated cells.

In some embodiments, the cryopreservation composition is incubated at room temperature for about 5 minutes, about 10 minutes, about 15 minutes, about 20 minutes, about 25 minutes, about 30 minutes, about 35 minutes, about 40 minutes, about 45 minutes, about 50 minutes, about 55 minutes, or about 60 minutes prior to cooling. In some embodiments, the cryopreservation composition is incubated at room temperature for about 5 minutes prior to cooling. In some embodiments, the cryopreservation composition is incubated at room temperature for about 10 minutes prior to cooling. In some embodiments, the cryopreservation composition is incubated at room temperature for about 15 minutes prior to cooling. In some embodiments, the cryopreservation composition is incubated at room temperature for about 20 minutes prior to cooling. In some embodiments, the cryopreservation composition is incubated at room temperature for about 25 minutes prior to cooling. In some embodiments, the cryopreservation composition is incubated at room temperature for about 30 minutes prior to cooling. In some embodiments, the cryopreservation composition is incubated at room temperature for about 35 minutes prior to cooling. In some embodiments, the cryopreservation composition is incubated at room temperature for about 40 minutes prior to cooling. In some embodiments, the cryopreservation composition is incubated at room temperature for about 45 minutes prior to cooling. In some embodiments, the cryopreservation composition is incubated at room temperature for about 50 minutes prior to cooling. In some embodiments, the cryopreservation composition is incubated at room temperature for about 55 minutes prior to cooling. In some embodiments, the cryopreservation composition is incubated at room temperature for about 60 minutes prior to cooling. As used herein, the term room temperature can refer to the ambient temperature of a room, such as about 18° C. to about 25° C. In some embodiments, room temperature refers to a temperature of about 20° C. to about 25° C. In some embodiments, room temperature refers to a temperature of about 22° C. to about 25° C.

In some embodiments, the cooling temperature is about −70° C. to about −200° C. In some embodiments, the cooling temperature is about −70° C. In some embodiments, the cooling temperature is about −80° C. In some embodiments, the cooling temperature is about −90° C. In some embodiments, the cooling temperature is about −100° C. In some embodiments, the cooling temperature is about −110° C. In some embodiments, the cooling temperature is about −120° C. In some embodiments, the cooling temperature is about −130° C. In some embodiments, the cooling temperature is about −140° C. In some embodiments, the cooling temperature is about −150° C. In some embodiments, the cooling temperature is about −160° C. In some embodiments, the cooling temperature is about −170° C. In some embodiments, the cooling temperature is about −180° C. In some embodiments, the cooling temperature is about −190° C. In some embodiments, the cooling temperature is about −196° C. In some embodiments, the cooling temperature is about −200° C.

In some embodiments, the composition is cooled at a rate of about 1° C. to about 5° C. per minute. In some embodiments, the composition is cooled at a rate of about 1° C. per minute, about 2° C. per minute, about 3° C. per minute, about 4° C. per minute, or about 5° C. per minute.

The composition can be cooled at such a rate until it reaches its final temperature to be stored at or it can be cooled at such a rate until an intermediate temperature at which point the rate of cooling can be increased or decreased.

In some embodiments, the composition is cooled by placing the composition in an liquid bath to facilitate the cooling and to regulate the rate at which the composition cools. This bath can be, for example, an alcohol, such as methanol, ethanol, or isopropanol. Thus, as a non-limiting example, a container comprising the composition can be placed in an alcohol bath and then can be placed in a freezer to freeze the composition. The freeze can be at a temperature that is set at −70° C. to about −200° C. In some embodiments, the composition is frozen at a temperature that is from about −70° C. to about 100° C. and then placed in liquid nitrogen. In some embodiments, the composition is not placed in liquid nitrogen or in a liquid nitrogen freezer.

In some embodiments, methods of maintaining viability of a population of encapsulated cells are provided. In some embodiments, the method comprises the step of adding an effective amount of a cryopreservation media to the population of encapsulated cells to form a cryopreservation composition. In some embodiments, the method comprises the step of incubating the cryopreservation composition at room temperature prior to cooling. In some embodiments, the method does not comprise the step of incubating the cryopreservation composition at room temperature prior to cooling. In some embodiments, the method comprises the optional step of incubating the cryopreservation composition at room temperature prior to cooling. In some embodiments, the method comprises the step of cooling the cryopreservation composition to a temperature sufficient to cryopreserve the cells. In some embodiments, the method comprises the step of maintaining the cryopreservation composition at a temperature sufficient to cryopreserve the cells. In some embodiments, the method comprises the step of thawing the cryopreservation composition under conditions sufficient to maintain viability of the population of encapsulated cells.

In some embodiments, a method of maintaining viability of a population of encapsulated cells is provided, wherein the method comprises the steps of adding an effective amount of a cryopreservation media to the population of encapsulated cells to form a cryopreservation composition; optionally, incubating the cryopreservation composition at room temperature prior to cooling; cooling the cryopreservation composition to a temperature sufficient to cryopreserve the cells; maintaining the cryopreservation composition at a temperature sufficient to cryopreserve the cells; and thawing the cryopreservation composition under conditions sufficient to maintain viability of the population of encapsulated cells.

In some embodiments, a method of maintaining viability of a population of encapsulated cells is provided, wherein the method comprises the steps of adding an effective amount of a cryopreservation media to the population of encapsulated cells to form a cryopreservation composition; incubating the cryopreservation composition at room temperature prior to cooling; cooling the cryopreservation composition to a temperature sufficient to cryopreserve the cells; maintaining the cryopreservation composition at a temperature sufficient to cryopreserve the cells; and thawing the cryopreservation composition under conditions sufficient to maintain viability of the population of encapsulated cells.

In some embodiments, a method of maintaining viability of a population of encapsulated cells is provided, wherein the method comprises the steps of adding an effective amount of a cryopreservation media to the population of encapsulated cells to form a cryopreservation composition; cooling the cryopreservation composition to a temperature sufficient to cryopreserve the cells; maintaining the cryopreservation composition at a temperature sufficient to cryopreserve the cells; and thawing the cryopreservation composition under conditions sufficient to maintain viability of the population of encapsulated cells.

In some embodiments, a method of maintaining viability of a population of encapsulated cells is provided, wherein the method comprises the steps of adding an effective amount of a cryopreservation media to the population of encapsulated cells to form a cryopreservation composition; optionally, incubating the cryopreservation composition at room temperature prior to cooling; cooling the cryopreservation composition to a temperature sufficient to cryopreserve the cells; maintaining the cryopreservation composition at a temperature sufficient to cryopreserve the cells; and thawing the cryopreservation composition under conditions sufficient to maintain viability of the population of encapsulated cells; wherein the thawing comprises the steps of thawing the cryopreservation composition; washing the population of encapsulated cells; and replacing the cryopreservation media with basal media.

In some embodiments, a method of maintaining viability of a population of encapsulated cells is provided, wherein the method comprises the steps of adding an effective amount of a cryopreservation media to the population of encapsulated cells to form a cryopreservation composition; optionally, incubating the cryopreservation composition at room temperature prior to cooling; cooling the cryopreservation composition to a temperature sufficient to cryopreserve the cells; maintaining the cryopreservation composition at a temperature sufficient to cryopreserve the cells; and thawing the cryopreservation composition under conditions sufficient to maintain viability of the population of encapsulated cells; and replacing the cryopreservation media with basal media; wherein the thawing comprises the steps of thawing the cryopreservation composition; washing the population of encapsulated cells; wherein the washing step comprises the steps of mixing the cryopreservation composition with thawing media to form a thawing composition; agitating the thawing composition on a tube rotator; or/and centrifuging the thawing composition.

In some embodiments, the centrifuging step is not performed and the capsules are allowed to concentrate by other methods. In some embodiments, the rotating step or agitating step is also not performed. Thus, where these steps are recited embodiments are also provided where such steps, i.e., agitation, rotation, and/or centrifugation are removed and such embodiments without such steps (e.g., agitation, rotation, and/or centrifugation) are provided herein.

In some embodiments, the temperature sufficient to maintain viability of the population of encapsulated cells is about −70° C. to about −200° C. In some embodiments, the temperature sufficient to maintain viability of the population of encapsulated cells is about −70° C. In some embodiments, the temperature sufficient to maintain viability of the population of encapsulated cells is about −80° C. In some embodiments, the temperature sufficient to maintain viability of the population of encapsulated cells is about −90° C. In some embodiments, the temperature sufficient to maintain viability of the population of encapsulated cells is about −100° C. In some embodiments, the temperature sufficient to maintain viability of the population of encapsulated cells is about −110° C. In some embodiments, the temperature sufficient to maintain viability of the population of encapsulated cells is about −120° C. In some embodiments, the temperature sufficient to maintain viability of the population of encapsulated cells is about −130° C. In some embodiments, the temperature sufficient to maintain viability of the population of encapsulated cells is about −140° C. In some embodiments, the temperature sufficient to maintain viability of the population of encapsulated cells is about −150° C. In some embodiments, the temperature sufficient to maintain viability of the population of encapsulated cells is about −160° C. In some embodiments, the temperature sufficient to maintain viability of the population of encapsulated cells is about −170° C. In some embodiments, the temperature sufficient to maintain viability of the population of encapsulated cells is about −180° C. In some embodiments, the temperature sufficient to maintain viability of the population of encapsulated cells is about −190° C. In some embodiments, the temperature sufficient to maintain viability of the population of encapsulated cells is about −196° C. In some embodiments, the temperature sufficient to maintain viability of the population of encapsulated cells is about −200° C.

In some embodiments, thawing comprises the steps of thawing the cryopreservation composition; washing the population of encapsulated cells; and replacing the cryopreservation media with basal media. In some embodiments, the thawing step comprises thawing the cryopreservation composition using a water bath or a controlled thawing device, such as but not limited to ThawSTAR®. In some embodiments, the thawing step comprises thawing the cryopreservation composition using ThawSTAR®. In some embodiments, the thawing step comprises thawing the cryopreservation composition using a water bath. In some embodiments, the water bath is at a temperature of about 15° C. to about 40° C. In some embodiments, the water bath is at a temperature of about 23° C. In some embodiments, the water bath is at a temperature of about 15° C. In some embodiments, the water bath is at a temperature of about 25° C. In some embodiments, the water bath is at a temperature of about 26° C. In some embodiments, the water bath is at a temperature of about 27° C. In some embodiments, the water bath is at a temperature of about 28° C. In some embodiments, the water bath is at a temperature of about 29° C. In some embodiments, the water bath is at a temperature of about 30° C. In some embodiments, the water bath is at a temperature of about 31° C. In some embodiments, the water bath is at a temperature of about 32° C. In some embodiments, the water bath is at a temperature of about 33° C. In some embodiments, the water bath is at a temperature of about 34° C. In some embodiments, the water bath is at a temperature of about 35° C. In some embodiments, the water bath is at a temperature of about 36° C. In some embodiments, the water bath is at a temperature of about 37° C. In some embodiments, the water bath is at a temperature of about 38° C. In some embodiments, the water bath is at a temperature of about 39° C. In some embodiments, the water bath is at a temperature of about 40° C.

In some embodiments, the washing step comprises the steps of mixing the cryopreservation composition with thawing media to form a thawing composition; agitating the thawing composition on a tube rotator; or/and centrifuging the thawing composition. In some embodiments, the washing step comprises the steps of mixing the cryopreservation composition with thawing media to form a thawing composition; and centrifuging the thawing composition. In some embodiments, the washing step comprises the steps of mixing the cryopreservation composition with thawing media to form a thawing composition; and agitating the thawing composition on a tube rotator. In some embodiments, the washing step comprises the steps of mixing the cryopreservation composition with thawing media to form a thawing composition; agitating the thawing composition on a tube rotator; and centrifuging the thawing composition.

In some embodiments, the washing step does not comprise mixing the cryopreservation composition with thawing media. In such an embodiments, the cryopreservation composition is allowed to thaw without the addition of a thawing media.

In some embodiments, the thawing media is selected from Cell Thawing Media 10% Dextran 40 (in 0.9% NaCl), Cell Thawing Media 10% Dextran 40 (in 5% Dextrose), DMEM, DMEM/F12, or RPMI. In some embodiments, the thawing media is saline, which can be referred to as normal saline. In some embodiments, the thawing media is Lactated Ringers (e.g. a sodium lactate solution, which can be a is a mixture of sodium chloride, sodium lactate, potassium chloride, and calcium chloride in water). In some embIn some embodiments, the thawing media is Cell Thawing Media 10% Dextran 40 (in 0.9% NaCl). In some embodiments, the thawing media is Cell Thawing Media 10% Dextran 40 (in 5% Dextrose). In some embodiments, the thawing media is DMEM. In some embodiments, the thawing media is DMEM/F12. In some embodiments, the thawing media is RPMI. In some embodiments, the thawing media is polyethylene glycol (PG), dimethyl sulfoxide (DMS), and sucrose in cell media. In some embodiments, the thawing media is about 0.1%-20% polyethylene glycol (PG), about 0.1%-20% dimethyl sulfoxide (DMS), and about 0.1%-20% sucrose in cell media. In some embodiments, the thawing media is about 11% polyethylene glycol (PG), about 11% dimethyl sulfoxide (DMS), and about 5% sucrose in cell media.

In some embodiments, the cryopreservation composition is mixed with the thawing media at a ratio of about 1 mL of the cryopreservation composition to about 100 mL, about 90 mL, about 80 mL, about 70 mL, about 60 mL, about 50 mL, about 40 mL, about 30 mL, about 20 mL, about 15 mL, about 10 mL, about 5 mL, or about 1 mL of thawing media. In some embodiments, the cryopreservation composition is mixed with the thawing media at a ratio of about 1 mL of the cryopreservation composition to about 100 mL of thawing media. In some embodiments, the cryopreservation composition is mixed with the thawing media at a ratio of about 1 mL of the cryopreservation composition to about 90 mL of thawing media. In some embodiments, the cryopreservation composition is mixed with the thawing media at a ratio of about 1 mL of the cryopreservation composition to about 80 mL of thawing media. In some embodiments, the cryopreservation composition is mixed with the thawing media at a ratio of about 1 mL of the cryopreservation composition to about 70 mL of thawing media. In some embodiments, the cryopreservation composition is mixed with the thawing media at a ratio of about 1 mL of the cryopreservation composition to about 60 mL of thawing media. In some embodiments, the cryopreservation composition is mixed with the thawing media at a ratio of about 1 mL of the cryopreservation composition to about 50 mL of thawing media. In some embodiments, the cryopreservation composition is mixed with the thawing media at a ratio of about 1 mL of the cryopreservation composition to about 40 mL of thawing media. In some embodiments, the cryopreservation composition is mixed with the thawing media at a ratio of about 1 mL of the cryopreservation composition to about 30 mL of thawing media. In some embodiments, the cryopreservation composition is mixed with the thawing media at a ratio of about 1 mL of the cryopreservation composition to about 20 mL of thawing media. In some embodiments, the cryopreservation composition is mixed with the thawing media at a ratio of about 1 mL of the cryopreservation composition to about 15 mL of thawing media. In some embodiments, the cryopreservation composition is mixed with the thawing media at a ratio of about 1 mL of the cryopreservation composition to about 10 mL of thawing media. In some embodiments, the cryopreservation composition is mixed with the thawing media at a ratio of about 1 mL of the cryopreservation composition to about 5 mL of thawing media. In some embodiments, the cryopreservation composition is mixed with the thawing media at a ratio of about 1 mL of the cryopreservation composition to about 1 mL of thawing media.

In some embodiments, the cryopreservation composition is mixed with Cell Thawing Media 10% Dextran 40 (in 0.9% NaCl) at a ratio of about 1 mL of the cryopreservation composition to about 100 mL, about 90 mL, about 80 mL, about 70 mL, about 60 mL, about 50 mL, about 40 mL, about 30 mL, about 20 mL, about 15 mL, about 10 mL, about 5 mL, or about 1 mL of Cell Thawing Media 10% Dextran 40 (in 0.9% NaCl). In some embodiments, the cryopreservation composition is mixed with Cell Thawing Media 10% Dextran 40 (in 0.9% NaCl) at a ratio of about 1 mL of the cryopreservation composition to about 100 mL of Cell Thawing Media 10% Dextran 40 (in 0.9% NaCl). In some embodiments, the cryopreservation composition is mixed with Cell Thawing Media 10% Dextran 40 (in 0.9% NaCl) at a ratio of about 1 mL of the cryopreservation composition to about 90 mL of Cell Thawing Media 10% Dextran 40 (in 0.9% NaCl). In some embodiments, the cryopreservation composition is mixed with Cell Thawing Media 10% Dextran 40 (in 0.9% NaCl) at a ratio of about 1 mL of the cryopreservation composition to about 80 mL of Cell Thawing Media 10% Dextran 40 (in 0.9% NaCl). In some embodiments, the cryopreservation composition is mixed with Cell Thawing Media 10% Dextran 40 (in 0.9% NaCl) at a ratio of about 1 mL of the cryopreservation composition to about 70 mL of Cell Thawing Media 10% Dextran 40 (in 0.9% NaCl). In some embodiments, the cryopreservation composition is mixed with Cell Thawing Media 10% Dextran 40 (in 0.9% NaCl) at a ratio of about 1 mL of the cryopreservation composition to about 60 mL of Cell Thawing Media 10% Dextran 40 (in 0.9% NaCl). In some embodiments, the cryopreservation composition is mixed with Cell Thawing Media 10% Dextran 40 (in 0.9% NaCl) at a ratio of about 1 mL of the cryopreservation composition to about 50 mL of Cell Thawing Media 10% Dextran 40 (in 0.9% NaCl). In some embodiments, the cryopreservation composition is mixed with Cell Thawing Media 10% Dextran 40 (in 0.9% NaCl) at a ratio of about 1 mL of the cryopreservation composition to about 40 mL of Cell Thawing Media 10% Dextran 40 (in 0.9% NaCl). In some embodiments, the cryopreservation composition is mixed with Cell Thawing Media 10% Dextran 40 (in 0.9% NaCl) at a ratio of about 1 mL of the cryopreservation composition to about 30 mL of Cell Thawing Media 10% Dextran 40 (in 0.9% NaCl). In some embodiments, the cryopreservation composition is mixed with Cell Thawing Media 10% Dextran 40 (in 0.9% NaCl) at a ratio of about 1 mL of the cryopreservation composition to about 20 mL of Cell Thawing Media 10% Dextran 40 (in 0.9% NaCl). In some embodiments, the cryopreservation composition is mixed with Cell Thawing Media 10% Dextran 40 (in 0.9% NaCl) at a ratio of about 1 mL of the cryopreservation composition to about 15 mL of Cell Thawing Media 10% Dextran 40 (in 0.9% NaCl). In some embodiments, the cryopreservation composition is mixed with Cell Thawing Media 10% Dextran 40 (in 0.9% NaCl) at a ratio of about 1 mL of the cryopreservation composition to about 10 mL of Cell Thawing Media 10% Dextran 40 (in 0.9% NaCl). In some embodiments, the cryopreservation composition is mixed with Cell Thawing Media 10% Dextran 40 (in 0.9% NaCl) at a ratio of about 1 mL of the cryopreservation composition to about 5 mL of Cell Thawing Media 10% Dextran 40 (in 0.9% NaCl). In some embodiments, the cryopreservation composition is mixed with Cell Thawing Media 10% Dextran 40 (in 0.9% NaCl) at a ratio of about 1 mL of the cryopreservation composition to about 1 mL of Cell Thawing Media 10% Dextran 40 (in 0.9% NaCl).

In some embodiments, the cryopreservation composition is mixed with about 0.1%-20% polyethylene glycol (PG), about 0.1%-20% dimethyl sulfoxide (DMS), and about 0.1%-20% sucrose in cell media at a ratio of about 1 mL of the cryopreservation composition to about 100 mL, about 90 mL, about 80 mL, about 70 mL, about 60 mL, about 50 mL, about 40 mL, about 30 mL, about 20 mL, about 15 mL, about 10 mL, about 5 mL, or about 1 mL of about 0.1%-20% polyethylene glycol (PG), about 0.1%-20% dimethyl sulfoxide (DMS), and about 0.1%-20% sucrose in cell media. In some embodiments, the cryopreservation composition is mixed with about 0.1%-20% polyethylene glycol (PG), about 0.1%-20% dimethyl sulfoxide (DMS), and about 0.1%-20% sucrose in cell media at a ratio of about 1 mL of the cryopreservation composition to about 100 mL of about 0.1%-20% polyethylene glycol (PG), about 0.1%-20% dimethyl sulfoxide (DMS), and about 0.1%-20% sucrose in cell media. In some embodiments, the cryopreservation composition is mixed with about 0.1%-20% polyethylene glycol (PG), about 0.1%-20% dimethyl sulfoxide (DMS), and about 0.1%-20% sucrose in cell media at a ratio of about 1 mL of the cryopreservation composition to about 90 mL of about 0.1%-20% polyethylene glycol (PG), about 0.1%-20% dimethyl sulfoxide (DMS), and about 0.1%-20% sucrose in cell media. In some embodiments, the cryopreservation composition is mixed with about 0.1%-20% polyethylene glycol (PG), about 0.1%-20% dimethyl sulfoxide (DMS), and about 0.1%-20% sucrose in cell media at a ratio of about 1 mL of the cryopreservation composition to about 80 mL of about 0.1%-20% polyethylene glycol (PG), about 0.1%-20% dimethyl sulfoxide (DMS), and about 0.1%-20% sucrose in cell media. In some embodiments, the cryopreservation composition is mixed with about 0.1%-20% polyethylene glycol (PG), about 0.1%-20% dimethyl sulfoxide (DMS), and about 0.1%-20% sucrose in cell media at a ratio of about 1 mL of the cryopreservation composition to about 70 mL of about 0.1%-20% polyethylene glycol (PG), about 0.1%-20% dimethyl sulfoxide (DMS), and about 0.1%-20% sucrose in cell media. In some embodiments, the cryopreservation composition is mixed with about 0.1%-20% polyethylene glycol (PG), about 0.1%-20% dimethyl sulfoxide (DMS), and about 0.1%-20% sucrose in cell media at a ratio of about 1 mL of the cryopreservation composition to about 60 mL of about 0.1%-20% polyethylene glycol (PG), about 0.1%-20% dimethyl sulfoxide (DMS), and about 0.1%-20% sucrose in cell media. In some embodiments, the cryopreservation composition is mixed with about 0.1%-20% polyethylene glycol (PG), about 0.1%-20% dimethyl sulfoxide (DMS), and about 0.1%-20% sucrose in cell media at a ratio of about 1 mL of the cryopreservation composition to about 50 mL of about 0.1%-20% polyethylene glycol (PG), about 0.1%-20% dimethyl sulfoxide (DMS), and about 0.1%-20% sucrose in cell media. In some embodiments, the cryopreservation composition is mixed with about 0.1%-20% polyethylene glycol (PG), about 0.1%-20% dimethyl sulfoxide (DMS), and about 0.1%-20% sucrose in cell media at a ratio of about 1 mL of the cryopreservation composition to about 40 mL of about 0.10%-20% polyethylene glycol (PG), about 0.1%-20% dimethyl sulfoxide (DMS), and about 0.1%-20% sucrose in cell media. In some embodiments, the cryopreservation composition is mixed with about 0.1%-20% polyethylene glycol (PG), about 0.1%-20% dimethyl sulfoxide (DMS), and about 0.1%-20% sucrose in cell media at a ratio of about 1 mL of the cryopreservation composition to about 30 mL of about 0.1%-20% polyethylene glycol (PG), about 0.1%-20% dimethyl sulfoxide (DMS), and about 0.1%-20% sucrose in cell media. In some embodiments, the cryopreservation composition is mixed with about 0.1%-20% polyethylene glycol (PG), about 0.1%-20% dimethyl sulfoxide (DMS), and about 0.1%-20% sucrose in cell media at a ratio of about 1 mL of the cryopreservation composition to about 20 mL of about 0.10%-20% polyethylene glycol (PG), about 0.1%-20% dimethyl sulfoxide (DMS), and about 0.1%-20% sucrose in cell media. In some embodiments, the cryopreservation composition is mixed with about 0.1%-20% polyethylene glycol (PG), about 0.1%-20% dimethyl sulfoxide (DMS), and about 0.1%-20% sucrose in cell media at a ratio of about 1 mL of the cryopreservation composition to about 15 mL of about 0.1%-20% polyethylene glycol (PG), about 0.1%-20% dimethyl sulfoxide (DMS), and about 0.1%-20% sucrose in cell media. In some embodiments, the cryopreservation composition is mixed with about 0.1%-20% polyethylene glycol (PG), about 0.1%-20% dimethyl sulfoxide (DMS), and about 0.1%-20% sucrose in cell media at a ratio of about 1 mL of the cryopreservation composition to about 10 mL of about 0.1%-20% polyethylene glycol (PG), about 0.1%-20% dimethyl sulfoxide (DMS), and about 0.1%-20% sucrose in cell media. In some embodiments, the cryopreservation composition is mixed with about 0.1%-20% polyethylene glycol (PG), about 0.1%-20% dimethyl sulfoxide (DMS), and about 0.1%-20% sucrose in cell media at a ratio of about 1 mL of the cryopreservation composition to about 5 mL of about 0.1%-20% polyethylene glycol (PG), about 0.1%-20% dimethyl sulfoxide (DMS), and about 0.1%-20% sucrose in cell media. In some embodiments, the cryopreservation composition is mixed with about 0.1%-20% polyethylene glycol (PG), about 0.1%-20% dimethyl sulfoxide (DMS), and about 0.1%-20% sucrose in cell media at a ratio of about 1 mL of the cryopreservation composition to about 1 mL of about 0.1%-20% polyethylene glycol (PG), about 0.1%-20% dimethyl sulfoxide (DMS), and about 0.1%-20% sucrose in cell media.

In some embodiments, the cryopreservation composition is mixed with Cell Thawing Media 10% Dextran 40 (in 5% Dextrose) at a ratio of about 1 mL of the cryopreservation composition to about 100 mL, about 90 mL, about 80 mL, about 70 mL, about 60 mL, about 50 mL, about 40 mL, about 30 mL, about 20 mL, about 15 mL, about 10 mL, about 5 mL, or about 1 mL of Cell Thawing Media 10% Dextran 40 (in 5% Dextrose). In some embodiments, the cryopreservation composition is mixed with Cell Thawing Media 10% Dextran 40 (in 5% Dextrose) at a ratio of about 1 mL of the cryopreservation composition to about 100 mL of Cell Thawing Media 10% Dextran 40 (in 5% Dextrose). In some embodiments, the cryopreservation composition is mixed with Cell Thawing Media 10% Dextran 40 (in 5% Dextrose) at a ratio of about 1 mL of the cryopreservation composition to about 90 mL of Cell Thawing Media 10% Dextran 40 (in 5% Dextrose). In some embodiments, the cryopreservation composition is mixed with Cell Thawing Media 10% Dextran 40 (in 5% Dextrose) at a ratio of about 1 mL of the cryopreservation composition to about 80 mL of Cell Thawing Media 10% Dextran 40 (in 5% Dextrose). In some embodiments, the cryopreservation composition is mixed with Cell Thawing Media 10% Dextran 40 (in 5% Dextrose) at a ratio of about 1 mL of the cryopreservation composition to about 70 mL of Cell Thawing Media 10% Dextran 40 (in 5% Dextrose). In some embodiments, the cryopreservation composition is mixed with Cell Thawing Media 10% Dextran 40 (in 5% Dextrose) at a ratio of about 1 mL of the cryopreservation composition to about 60 mL of Cell Thawing Media 10% Dextran 40 (in 5% Dextrose). In some embodiments, the cryopreservation composition is mixed with Cell Thawing Media 10% Dextran 40 (in 5% Dextrose) at a ratio of about 1 mL of the cryopreservation composition to about 50 mL of Cell Thawing Media 10% Dextran 40 (in 5% Dextrose). In some embodiments, the cryopreservation composition is mixed with Cell Thawing Media 10% Dextran 40 (in 5% Dextrose) at a ratio of about 1 mL of the cryopreservation composition to about 40 mL of Cell Thawing Media 10% Dextran 40 (in 5% Dextrose). In some embodiments, the cryopreservation composition is mixed with Cell Thawing Media 10% Dextran 40 (in 5% Dextrose) at a ratio of about 1 mL of the cryopreservation composition to about 30 mL of Cell Thawing Media 10% Dextran 40 (in 5% Dextrose). In some embodiments, the cryopreservation composition is mixed with Cell Thawing Media 10% Dextran 40 (in 5% Dextrose) at a ratio of about 1 mL of the cryopreservation composition to about 20 mL of Cell Thawing Media 10% Dextran 40 (in 5% Dextrose). In some embodiments, the cryopreservation composition is mixed with Cell Thawing Media 10% Dextran 40 (in 5% Dextrose) at a ratio of about 1 mL of the cryopreservation composition to about 15 mL of Cell Thawing Media 10% Dextran 40 (in 5% Dextrose). In some embodiments, the cryopreservation composition is mixed with Cell Thawing Media 10% Dextran 40 (in 5% Dextrose) at a ratio of about 1 mL of the cryopreservation composition to about 10 mL of Cell Thawing Media 10% Dextran 40 (in 5% Dextrose). In some embodiments, the cryopreservation composition is mixed with Cell Thawing Media 10% Dextran 40 (in 5% Dextrose) at a ratio of about 1 mL of the cryopreservation composition to about 5 mL of Cell Thawing Media 10% Dextran 40 (in 5% Dextrose). In some embodiments, the cryopreservation composition is mixed with Cell Thawing Media 10% Dextran 40 (in 5% Dextrose) at a ratio of about 1 mL of the cryopreservation composition to about 1 mL of Cell Thawing Media 10% Dextran 40 (in 5% Dextrose).

In some embodiments, the cryopreservation composition is mixed with DMEM at a ratio of about 1 mL of the cryopreservation composition to about 100 mL, about 90 mL, about 80 mL, about 70 mL, about 60 mL, about 50 mL, about 40 mL, about 30 mL, about 20 mL, about 15 mL, about 10 mL, about 5 mL, or about 1 mL of DMEM. In some embodiments, the cryopreservation composition is mixed with DMEM at a ratio of about 1 mL of the cryopreservation composition to about 100 mL of DMEM. In some embodiments, the cryopreservation composition is mixed with DMEM at a ratio of about 1 mL of the cryopreservation composition to about 90 mL of DMEM. In some embodiments, the cryopreservation composition is mixed with DMEM at a ratio of about 1 mL of the cryopreservation composition to about 80 mL of DMEM. In some embodiments, the cryopreservation composition is mixed with DMEM at a ratio of about 1 mL of the cryopreservation composition to about 70 mL of DMEM. In some embodiments, the cryopreservation composition is mixed with DMEM at a ratio of about 1 mL of the cryopreservation composition to about 60 mL of DMEM. In some embodiments, the cryopreservation composition is mixed with DMEM at a ratio of about 1 mL of the cryopreservation composition to about 50 mL of DMEM. In some embodiments, the cryopreservation composition is mixed with DMEM at a ratio of about 1 mL of the cryopreservation composition to about 40 mL of DMEM. In some embodiments, the cryopreservation composition is mixed with DMEM at a ratio of about 1 mL of the cryopreservation composition to about 30 mL of DMEM. In some embodiments, the cryopreservation composition is mixed with DMEM at a ratio of about 1 mL of the cryopreservation composition to about 20 mL of DMEM. In some embodiments, the cryopreservation composition is mixed with DMEM at a ratio of about 1 mL of the cryopreservation composition to about 15 mL of DMEM. In some embodiments, the cryopreservation composition is mixed with DMEM at a ratio of about 1 mL of the cryopreservation composition to about 10 mL of DMEM. In some embodiments, the cryopreservation composition is mixed with DMEM at a ratio of about 1 mL of the cryopreservation composition to about 5 mL of DMEM. In some embodiments, the cryopreservation composition is mixed with DMEM at a ratio of about 1 mL of the cryopreservation composition to about 1 mL of DMEM.

In some embodiments, the cryopreservation composition is mixed with DMEM/F12 at a ratio of about 1 mL of the cryopreservation composition to about 100 mL, about 90 mL, about 80 mL, about 70 mL, about 60 mL, about 50 mL, about 40 mL, about 30 mL, about 20 mL, about 15 mL, about 10 mL, about 5 mL, or about 1 mL of DMEM/F12. In some embodiments, the cryopreservation composition is mixed with DMEM/F12 at a ratio of about 1 mL of the cryopreservation composition to about 100 mL of DMEM/F12. In some embodiments, the cryopreservation composition is mixed with DMEM/F12 at a ratio of about 1 mL of the cryopreservation composition to about 90 mL of DMEM/F12. In some embodiments, the cryopreservation composition is mixed with DMEM/F12 at a ratio of about 1 mL of the cryopreservation composition to about 80 mL of DMEM/F12. In some embodiments, the cryopreservation composition is mixed with DMEM/F12 at a ratio of about 1 mL of the cryopreservation composition to about 70 mL of DMEM/F12. In some embodiments, the cryopreservation composition is mixed with DMEM/F12 at a ratio of about 1 mL of the cryopreservation composition to about 60 mL of DMEM/F12. In some embodiments, the cryopreservation composition is mixed with DMEM/F12 at a ratio of about 1 mL of the cryopreservation composition to about 50 mL of DMEM/F12. In some embodiments, the cryopreservation composition is mixed with DMEM/F12 at a ratio of about 1 mL of the cryopreservation composition to about 40 mL of DMEM/F12. In some embodiments, the cryopreservation composition is mixed with DMEM/F12 at a ratio of about 1 mL of the cryopreservation composition to about 30 mL of DMEM/F12. In some embodiments, the cryopreservation composition is mixed with DMEM/F12 at a ratio of about 1 mL of the cryopreservation composition to about 20 mL of DMEM/F12. In some embodiments, the cryopreservation composition is mixed with DMEM/F12 at a ratio of about 1 mL of the cryopreservation composition to about 15 mL of DMEM/F12. In some embodiments, the cryopreservation composition is mixed with DMEM/F12 at a ratio of about 1 mL of the cryopreservation composition to about 10 mL of DMEM/F12. In some embodiments, the cryopreservation composition is mixed with DMEM/F12 at a ratio of about 1 mL of the cryopreservation composition to about 5 mL of DMEM/F12. In some embodiments, the cryopreservation composition is mixed with DMEM/F12 at a ratio of about 1 mL of the cryopreservation composition to about 1 mL of DMEM/F12.

In some embodiments, the cryopreservation composition is mixed with RPMI at a ratio of about 1 mL of the cryopreservation composition to about 100 mL, about 90 mL, about 80 mL, about 70 mL, about 60 mL, about 50 mL, about 40 mL, about 30 mL, about 20 mL, about 15 mL, about 10 mL, about 5 mL, or about 1 mL of RPMI. In some embodiments, the cryopreservation composition is mixed with RPMI at a ratio of about 1 mL of the cryopreservation composition to about 100 mL of RPMI. In some embodiments, the cryopreservation composition is mixed with RPMI at a ratio of about 1 mL of the cryopreservation composition to about 90 mL of RPMI. In some embodiments, the cryopreservation composition is mixed with RPMI at a ratio of about 1 mL of the cryopreservation composition to about 80 mL of RPMI. In some embodiments, the cryopreservation composition is mixed with RPMI at a ratio of about 1 mL of the cryopreservation composition to about 70 mL of RPMI. In some embodiments, the cryopreservation composition is mixed with RPMI at a ratio of about 1 mL of the cryopreservation composition to about 60 mL of RPMI. In some embodiments, the cryopreservation composition is mixed with RPMI at a ratio of about 1 mL of the cryopreservation composition to about 50 mL of RPMI. In some embodiments, the cryopreservation composition is mixed with RPMI at a ratio of about 1 mL of the cryopreservation composition to about 40 mL of RPMI. In some embodiments, the cryopreservation composition is mixed with RPMI at a ratio of about 1 mL of the cryopreservation composition to about 30 mL of RPMI. In some embodiments, the cryopreservation composition is mixed with RPMI at a ratio of about 1 mL of the cryopreservation composition to about 20 mL of RPMI. In some embodiments, the cryopreservation composition is mixed with RPMI at a ratio of about 1 mL of the cryopreservation composition to about 15 mL of RPMI. In some embodiments, the cryopreservation composition is mixed with RPMI at a ratio of about 1 mL of the cryopreservation composition to about 10 mL of RPMI. In some embodiments, the cryopreservation composition is mixed with RPMI at a ratio of about 1 mL of the cryopreservation composition to about 5 mL of RPMI. In some embodiments, the cryopreservation composition is mixed with RPMI at a ratio of about 1 mL of the cryopreservation composition to about 1 mL of RPMI.

In some embodiments, the agitating step comprises rotating the population of cells on a tube rotator at a rate of 0-40 rotations per minute for about 60 minutes, about 50 minutes, about 45 minutes, about 40 minutes, about 35 minutes, about 30 minutes, about 25 minutes, about 20 minutes, about 15 minutes, about 10 minutes, or about 5 minutes. In some embodiments, the cells are not agitated or rotated. In some embodiments, the agitating step comprises rotating the population of cells on a tube rotator at a rate of 30 rotations per minute for about 60 minutes. In some embodiments, the agitating step comprises rotating the population of cells on a tube rotator at a rate of 30 rotations per minute for about 50 minutes. In some embodiments, the agitating step comprises rotating the population of cells on a tube rotator at a rate of 30 rotations per minute for about 45 minutes. In some embodiments, the agitating step comprises rotating the population of cells on a tube rotator at a rate of 30 rotations per minute for about 40 minutes. In some embodiments, the agitating step comprises rotating the population of cells on a tube rotator at a rate of 30 rotations per minute for about 35 minutes. In some embodiments, the agitating step comprises rotating the population of cells on a tube rotator at a rate of 30 rotations per minute for about 30 minutes. In some embodiments, the agitating step comprises rotating the population of cells on a tube rotator at a rate of 30 rotations per minute for about 25 minutes. In some embodiments, the agitating step comprises rotating the population of cells on a tube rotator at a rate of 30 rotations per minute for about 20 minutes. In some embodiments, the agitating step comprises rotating the population of cells on a tube rotator at a rate of 30 rotations per minute for about 15 minutes. In some embodiments, the agitating step comprises rotating the population of cells on a tube rotator at a rate of 30 rotations per minute for about 10 minutes. In some embodiments, the agitating step comprises rotating the population of cells on a tube rotator at a rate of 30 rotations per minute for about 5 minutes. In some embodiments, the agitating step comprises rotating the population of cells on a tube rotator at a rate of 40 rotations per minute for about 50 minutes. In some embodiments, the agitating step comprises rotating the population of cells on a tube rotator at a rate of 40 rotations per minute for about 45 minutes. In some embodiments, the agitating step comprises rotating the population of cells on a tube rotator at a rate of 40 rotations per minute for about 40 minutes. In some embodiments, the agitating step comprises rotating the population of cells on a tube rotator at a rate of 40 rotations per minute for about 35 minutes. In some embodiments, the agitating step comprises rotating the population of cells on a tube rotator at a rate of 40 rotations per minute for about 30 minutes. In some embodiments, the agitating step comprises rotating the population of cells on a tube rotator at a rate of 40 rotations per minute for about 25 minutes. In some embodiments, the agitating step comprises rotating the population of cells on a tube rotator at a rate of 40 rotations per minute for about 20 minutes. In some embodiments, the agitating step comprises rotating the population of cells on a tube rotator at a rate of 40 rotations per minute for about 15 minutes. In some embodiments, the agitating step comprises rotating the population of cells on a tube rotator at a rate of 40 rotations per minute for about 10 minutes. In some embodiments, the agitating step comprises rotating the population of cells on a tube rotator at a rate of 40 rotations per minute for about 5 minutes. In some embodiments, the agitating step comprises rotating the population of cells on a tube rotator at a rate of 20 rotations per minute for about 50 minutes. In some embodiments, the agitating step comprises rotating the population of cells on a tube rotator at a rate of 20 rotations per minute for about 45 minutes. In some embodiments, the agitating step comprises rotating the population of cells on a tube rotator at a rate of 20 rotations per minute for about 40 minutes. In some embodiments, the agitating step comprises rotating the population of cells on a tube rotator at a rate of 20 rotations per minute for about 35 minutes. In some embodiments, the agitating step comprises rotating the population of cells on a tube rotator at a rate of 20 rotations per minute for about 30 minutes. In some embodiments, the agitating step comprises rotating the population of cells on a tube rotator at a rate of 20 rotations per minute for about 25 minutes. In some embodiments, the agitating step comprises rotating the population of cells on a tube rotator at a rate of 20 rotations per minute for about 20 minutes. In some embodiments, the agitating step comprises rotating the population of cells on a tube rotator at a rate of 20 rotations per minute for about 15 minutes. In some embodiments, the agitating step comprises rotating the population of cells on a tube rotator at a rate of 20 rotations per minute for about 10 minutes. In some embodiments, the agitating step comprises rotating the population of cells on a tube rotator at a rate of 20 rotations per minute for about 5 minutes. In some embodiments, the agitating step comprises rotating the population of cells on a tube rotator at a rate of 10 rotations per minute for about 50 minutes. In some embodiments, the agitating step comprises rotating the population of cells on a tube rotator at a rate of 10 rotations per minute for about 45 minutes. In some embodiments, the agitating step comprises rotating the population of cells on a tube rotator at a rate of 10 rotations per minute for about 40 minutes. In some embodiments, the agitating step comprises rotating the population of cells on a tube rotator at a rate of 10 rotations per minute for about 35 minutes. In some embodiments, the agitating step comprises rotating the population of cells on a tube rotator at a rate of 10 rotations per minute for about 30 minutes. In some embodiments, the agitating step comprises rotating the population of cells on a tube rotator at a rate of 10 rotations per minute for about 25 minutes. In some embodiments, the agitating step comprises rotating the population of cells on a tube rotator at a rate of 10 rotations per minute for about 20 minutes. In some embodiments, the agitating step comprises rotating the population of cells on a tube rotator at a rate of 10 rotations per minute for about 15 minutes. In some embodiments, the agitating step comprises rotating the population of cells on a tube rotator at a rate of 10 rotations per minute for about 10 minutes. In some embodiments, the agitating step comprises rotating the population of cells on a tube rotator at a rate of 10 rotations per minute for about 5 minutes.

In some embodiments, the centrifuging step comprises centrifuging the population of encapsulated cells at a rate of about 1000, about 900, about 800, about 700, about 600, about 500, or about 100 rotations per minute for about 3 minutes. In some embodiments, the centrifuging step comprises centrifuging the population of encapsulated cells at a rate of about 1000 rotations per minute for about 3 minutes. In some embodiments, the centrifuging step comprises centrifuging the population of encapsulated cells at a rate of about 900 rotations per minute for about 3 minutes. In some embodiments, the centrifuging step comprises centrifuging the population of encapsulated cells at a rate of about 800 rotations per minute for about 3 minutes3 In some embodiments, the centrifuging step comprises centrifuging the population of encapsulated cells at a rate of about 700 rotations per minute for about 3 minutes. In some embodiments, the centrifuging step comprises centrifuging the population of encapsulated cells at a rate of about 600 rotations per minute for about 3 minutes. In some embodiments, the centrifuging step comprises centrifuging the population of encapsulated cells at a rate of about 500 rotations per minute for about 3 minutes. In some embodiments, the centrifuging step comprises centrifuging the population of encapsulated cells at a rate of about 400 rotations per minute for about 3 minutes. In some embodiments, the centrifuging step comprises centrifuging the population of encapsulated cells at a rate of about 300 rotations per minute for about 3 minutes. In some embodiments, the centrifuging step comprises centrifuging the population of encapsulated cells at a rate of about 200 rotations per minute for about 3 minutes. In some embodiments, the centrifuging step comprises centrifuging the population of encapsulated cells at a rate of about 100 rotations per minute for about 3 minutes. In some embodiments, the centrifugation is performed to concentrate the encapsulated cells (e.g., the capsules). The capsules can be centrifuged and the media can be removed to a volume that is sufficient.

In some embodiments, the basal media is selected from DMEM, DMEM/F12, DMEM/F12+10% FBS, or RPMI. As used herein, the term “basal media” is meant to refer to basal media and/or cell media. In some embodiments, the basal media is DMEM. In some embodiments, the basal media is DMEM/F12. In some embodiments, the basal media is DMEM/F12+10% FBS. In some embodiments, the basal media is RPMI. In some embodiments, the basal media is a media containing human albumin at a concentration of about 0-15%. In some embodiments, the basal media is a media that does not contain human albumin. In some embodiments, the basal media is a media containing human albumin at a concentration of about 1%. In some embodiments, the basal media is a media containing human albumin at a concentration of about 2%. In some embodiments, the basal media is a media containing human albumin at a concentration of about 3%. In some embodiments, the basal media is a media containing human albumin at a concentration of about 4%. In some embodiments, the basal media is a media containing human albumin at a concentration of about 5%. In some embodiments, the basal media is a media containing human albumin at a concentration of about 6%. In some embodiments, the basal media is a media containing human albumin at a concentration of about 7%. In some embodiments, the basal media is a media containing human albumin at a concentration of about 8%. In some embodiments, the basal media is a media containing human albumin at a concentration of about 9%. In some embodiments, the basal media is a media containing human albumin at a concentration of about 10%. In some embodiments, the basal media is a media containing human albumin at a concentration of about 11%. In some embodiments, the basal media is a media containing human albumin at a concentration of about 12%. In some embodiments, the basal media is a media containing human albumin at a concentration of about 13%. In some embodiments, the basal media is a media containing human albumin at a concentration of about 14%. In some embodiments, the basal media is a media containing human albumin at a concentration of about 15%.

In some embodiments, the population of encapsulated cells has a post-thawing viability of at least 40%, at least 50%, at least 60%, or at least 70%. In some embodiments, the population of encapsulated cells has a post-thawing viability of at least 40%. In some embodiments, the population of encapsulated cells has a post-thawing viability of at least 50%. In some embodiments, the population of encapsulated cells has a post-thawing viability of at least 60%. In some embodiments, the population of encapsulated cells has a post-thawing viability of at least 70%. In some embodiments, the encapsulated cells retain about 10 to about 40% viability, about 40% to about 70% viability, at least 40% viability, at least 50% viability, at least 60% viability, at least 70% viability, at least 80% viability, or at least 90% viability after being frozen in the cryopreservation media for about, or at least, 1 day, 1 week, 1 month, 2 months, 3 months, 4 months, 5 months, 6 months, 9 months, or 12 months.

In some embodiments, methods provided herein maintain encapsulated cell viability. In some embodiments, the cells remain viable for at least 1, 2, 3, 4, 5, 10, 15, 20, 40, or 180 days. In some embodiments, the cells remain viable for at least 1 day. In some embodiments, the cells remain viable for at least 2 days. In some embodiments, the cells remain viable for at least 3 days. In some embodiments, the cells remain viable for at least 4 days. In some embodiments, the cells remain viable for at least 5 days. In some embodiments, the cells remain viable for at least 10 days. In some embodiments, the cells remain viable for at least 15 days. In some embodiments, the cells remain viable for at least 20 days. In some embodiments, the cells remain viable for at least 40 days. In some embodiments, the cells remain viable for at least 180 days.

In some embodiments compositions comprising a cryopreservation media and a plurality of encapsulated cells is provided. In some embodiments, the cryopreservation media is a media as provided for herein. In some embodiments, the media is BAMBANKER™ or BamBanker HRM. In some embodiments, the cryopreservation media is CryoStor® CS10. In some embodiments, the cryopreservation media is CryoStor® CS5. In some embodiments, the cryopreservation media is CTS™ Synth-a-Freeze™. In some embodiments, the cryopreservation media is 10% DMSO and 10% human serum albumin (HAS). In some embodiments, the cryopreservation media is propylene glycol (PG). In some embodiments, the cryopreservation media is ethylene glycol (EG). In some embodiments, the cryopreservation media is dimethyl sulfoxide (DMSO). In some embodiments, the cryopreservation media is polyethylene glycol (PEG). In some embodiments, the cryopreservation media is a combination of propylene glycol (PG), ethylene glycol (EG), and dimethyl sulfoxide (DMSO) in cell media. In some embodiments, the cryopreservation media is a combination of propylene glycol (PG) and dimethyl sulfoxide (DMSO) in cell media. In some embodiments, the cryopreservation media is ethylene glycol (EG) and dimethyl sulfoxide (DMSO) in cell media. In some embodiments, the cryopreservation media is about⁴-50% of propylene glycol (PG), ethylene glycol (EG), dimethyl sulfoxide (DMSO), or any combination thereof, in cell media. In some embodiments, the cryopreservation media is about 4% of propylene glycol (PG), ethylene glycol (EG), dimethyl sulfoxide (DMSO), or any combination thereof, in cell media. In some embodiments, the cryopreservation media is about 4.4% of propylene glycol (PG), ethylene glycol (EG), dimethyl sulfoxide (DMSO), or any combination thereof, in cell media. In some embodiments, the cryopreservation media is about 16% of propylene glycol (PG), ethylene glycol (EG), dimethyl sulfoxide (DMSO), or any combination thereof, in cell media. In some embodiments, the cryopreservation media is about 22% of propylene glycol (PG), ethylene glycol (EG), dimethyl sulfoxide (DMSO), or any combination thereof, in cell media. In some embodiments, the cryopreservation media is about 27% of propylene glycol (PG), ethylene glycol (EG), dimethyl sulfoxide (DMSO), or any combination thereof, in cell media. In some embodiments, the cryopreservation media is about 44% of propylene glycol (PG), ethylene glycol (EG), dimethyl sulfoxide (DMSO), or any combination thereof, in cell media. In some embodiments, the cryopreservation media is about 4% of propylene glycol (PG) and dimethyl sulfoxide (DMSO) in cell media. In some embodiments, the cryopreservation media is about 4.4% of propylene glycol (PG) and dimethyl sulfoxide (DMSO) in cell media. In some embodiments, the cryopreservation media is about 16% of propylene glycol (PG) and dimethyl sulfoxide (DMSO) in cell media. In some embodiments, the cryopreservation media is about 22% of propylene glycol (PG) and dimethyl sulfoxide (DMSO) in cell media. In some embodiments, the cryopreservation media is about 27% of propylene glycol (PG) and dimethyl sulfoxide (DMSO) in cell media. In some embodiments, the cryopreservation media is about 44% of propylene glycol (PG) and dimethyl sulfoxide (DMSO) in cell media. In some embodiments, the cryopreservation media is about 4% of ethylene glycol (EG) and dimethyl sulfoxide (DMSO) in cell media. In some embodiments, the cryopreservation media is about 4.4% of ethylene glycol (EG) and dimethyl sulfoxide (DMSO) in cell media. In some embodiments, the cryopreservation media comprises about 16% of ethylene glycol (EG) and dimethyl sulfoxide (DMSO) in cell media. In some embodiments, the cryopreservation media is about 22% of ethylene glycol (EG) and dimethyl sulfoxide (DMSO) in cell media. In some embodiments, the cryopreservation media is about 27% of ethylene glycol (EG) and dimethyl sulfoxide (DMSO) in cell media. In some embodiments, the cryopreservation media is about 44% of ethylene glycol (EG) and dimethyl sulfoxide (DMSO) in cell media.

In some embodiments, the media comprises about 1 to about 50% (w/v) of HSA. In some embodiments, the media comprises about 1 to about 40% (w/v) of HSA. In some embodiments, the media comprises about 1 to about 30% (w/v) of HSA. In some embodiments, the media comprises about 1 to about 20% (w/v) of HSA. In some embodiments, the media comprises about 1 to about 10% (w/v) of HSA. In some embodiments, the media comprises about 5 to about 50% (w/v) of HSA. In some embodiments, the media comprises about 5 to about 40% (w/v) of HSA. In some embodiments, the media comprises about 5 to about 30% (w/v) of HSA. In some embodiments, the media comprises about 5 to about 20% (w/v) of HSA. In some embodiments, the media comprises about 5 to about 10% (w/v) of HSA. In some embodiments, the media comprises about 10 to about 50% (w/v) of HSA. In some embodiments, the media comprises about 10 to about 40% (w/v) of HSA. In some embodiments, the media comprises about 10 to about 30% (w/v) of HSA. In some embodiments, the media comprises about 10 to about 20% (w/v) of HSA. In some embodiments, the media comprises about 20 to about 50% (w/v) of HSA. In some embodiments, the media comprises about 20 to about 40% (w/v) of HSA. In some embodiments, the media comprises about 20 to about 30% (w/v) of HSA. In some embodiments, the media comprises about 30 to about 50% (w/v) of HSA. In some embodiments, the media comprises about 30 to about 40% (w/v) of HSA. In some embodiments, the media comprises about 40 to about 50% (w/v) of HSA.

In some embodiments, the cryopreservation media or the thawing media is as provided in Zhan Li, et al., which is hereby incorporated by reference in its entirety (Zhan Li, et al. Pancreatic islet cryopreservation by vitrification achieves high viability, function, recovery and clinical scalability for transplantation. Nature Medicine (2022), https://doi.org/10.1038/s41591-022-01718-1).

In some embodiments, compositions comprising 10% DMSO, 10% HSA, and a plurality of encapsulated cells as provided herein, are provided.

Also provided herein are methods of treatment or methods of use of the frozen encapsulated cells. For example, the encapsulated cells can be thawed according to a method provided for herein and administered to a subject to treat a subject with a disease or condition. For example, the thawed encapsulated cells can be implanted into a subject to treat a disease or condition such as cancer. Methods of using such encapsulated cells can be found in PCT Publication No. WO2021026484, which is hereby incorporated by reference in its entirety.

Briefly, in some embodiments, the thawed encapsulated cells are uses to treat a proliferative disease. In some embodiments, the proliferative disease is cancer. A cancer may be an epithelial, mesenchymal, or hematological malignancy. A cancer includes primary malignant cells or tumors (e.g., those whose cells have not migrated to sites in the subject's body other than the site of the original malignancy or tumor) and secondary malignant cells or tumors (e.g, those arising from metastasis, the migration of malignant cells or tumor cells to secondary sites that are different from the site of the original tumor). In an embodiment, the cancer is a solid tumor (e.g, carcinoid, carcinoma or sarcoma), a soft tissue tumor (e.g, a heme malignancy), or a metastatic lesion, e.g, a metastatic lesion of any of the cancers disclosed herein. In an embodiment, the cancer is a fibrotic or desmoplastic solid tumor.

Exemplary cancers include carcinoma, lymphoma, blastoma, sarcoma, and leukemia or lymphoid malignancies. In an embodiment, the cancer affects a system of the body, e.g, the nervous system (e.g, peripheral nervous system (PNS) or central nervous system (CNS)), vascular system, skeletal system, respiratory system, endocrine system, lymph system, reproductive system, or gastrointestinal tract. In some embodiments, cancer affects a part of the body, e.g, blood, eye, brain, skin, lung, stomach, mouth, ear, leg, foot, hand, liver, heart, kidney, bone, pancreas, spleen, large intestine, small intestine, spinal cord, muscle, ovary, uterus, vagina, or penis. More particular examples of such cancers include squamous cell cancer (e.g, epithelial squamous cell cancer), lung cancer including small-cell lung cancer, non-small cell lung cancer, adenocarcinoma of the lung and squamous carcinoma of the lung, cancer of the peritoneum, hepatocellular cancer, gastric or stomach cancer including gastrointestinal cancer, pancreatic cancer, glioblastoma, cervical cancer, ovarian cancer, liver cancer, bladder cancer, hepatoma, breast cancer, colon cancer, rectal cancer, colorectal cancer, endometrial cancer or uterine carcinoma, salivary gland carcinoma, kidney or renal cancer, prostate cancer, vulval cancer, thyroid cancer, hepatic carcinoma, anal carcinoma, penile carcinoma, as well as head and neck cancer.

Other examples of cancers include, but are not limited to: Acute Childhood Lymphoblastic Leukemia, Acute Lymphoblastic Leukemia, Acute Lymphocytic Leukemia, Acute Myeloid Leukemia, Adrenocortical Carcinoma, Adult (Primary) Hepatocellular Cancer, Adult (Primary) Liver Cancer, Adult Acute Lymphocytic Leukemia, Adult Acute Myeloid Leukemia, Adult Hodgkin's Disease, Adult Hodgkin's Lymphoma, Adult Lymphocytic Leukemia, Adult Non-Hodgkin's Lymphoma, Adult Primary Liver Cancer, Adult Soft Tissue Sarcoma, AIDS-Related Lymphoma, AIDS-Related Malignancies, Anal Cancer, Astrocytoma, Bile Duct Cancer, Bladder Cancer, Bone Cancer, Brain Stem Glioma, Brain Tumors, Breast Cancer, Cancer of the Renal Pelvis and Ureter, Central Nervous System (Primary) Lymphoma, Central Nervous System Lymphoma, Cerebellar Astrocytoma, Cerebral Astrocytoma, Cervical Cancer, Childhood (Primary) Hepatocellular Cancer, Childhood (Primary) Liver Cancer, Childhood Acute Lymphoblastic Leukemia, Childhood Acute Myeloid Leukemia, Childhood Brain Stem Glioma, Childhood Cerebellar Astrocytoma, Childhood Cerebral Astrocytoma, Childhood Extracranial Germ Cell Tumors, Childhood Hodgkin's Disease, Childhood Hodgkin's Lymphoma, Childhood Hypothalamic and Visual Pathway Glioma, Childhood Lymphoblastic Leukemia, Childhood Medulloblastoma, Childhood Non-Hodgkin's Lymphoma, Childhood Pineal and Supratentorial Primitive Neuroectodermal Tumors, Childhood Primary Liver Cancer, Childhood Rhabdomyosarcoma, Childhood Soft Tissue Sarcoma, Childhood Visual Pathway and Hypothalamic Glioma, Chronic Lymphocytic Leukemia, Chronic Myelogenous Leukemia, Colon Cancer, Cutaneous T-Cell Lymphoma, Endocrine Pancreas Islet Cell Carcinoma, Endometrial Cancer, Ependymoma, Epithelial Cancer, Esophageal Cancer, Ewing's Sarcoma and Related Tumors, Exocrine Pancreatic Cancer, Extracranial Germ Cell Tumor, Extragonadal Germ Cell Tumor, Extrahepatic Bile Duct Cancer, Eye Cancer, Female Breast Cancer, Gaucher's Disease, Gallbladder Cancer, Gastric Cancer, Gastrointestinal Carcinoid Tumor, Gastrointestinal Tumors, Germ Cell Tumors, Gestational Trophoblastic Tumor, Hairy Cell Leukemia, Head and Neck Cancer, Hepatocellular Cancer, Hodgkin's Disease, Hodgkin's Lymphoma, Hypergammaglobulinemia,

Hypopharyngeal Cancer, Intestinal Cancers, Intraocular Melanoma, Islet Cell Carcinoma, Islet Cell Pancreatic Cancer, Kaposi's Sarcoma, Kidney Cancer, Laryngeal Cancer, Lip and Oral Cavity Cancer, Liver Cancer, Lung Cancer, Lymphoproliferative Disorders, Macroglobulinemia, Male Breast Cancer, Malignant Mesothelioma, Malignant Thymoma, Medulloblastoma, Melanoma, Mesothelioma, Metastatic Occult Primary Squamous Neck Cancer, Metastatic Primary Squamous Neck Cancer, Metastatic Squamous Neck Cancer, Multiple Myeloma, Multiple Myeloma/Plasma Cell Neoplasm, Myelodysplastic Syndrome, Myelogenous Leukemia, Myeloid Leukemia, Myeloproliferative Disorders, Nasal Cavity and Paranasal Sinus Cancer, Nasopharyngeal Cancer, Neuroblastoma, Non-Hodgkin's Lymphoma During Pregnancy, Nonmelanoma Skin Cancer, Non-Small Cell Lung Cancer, Occult Primary Metastatic Squamous Neck Cancer, Oropharyngeal Cancer, Osteo-/Malignant Fibrous Sarcoma, Osteosarcoma/Malignant Fibrous Histiocytoma, Osteosarcoma/Malignant Fibrous Histiocytoma of Bone, Ovarian Epithelial Cancer, Ovarian Germ Cell Tumor, Ovarian Low Malignant Potential Tumor, Pancreatic Cancer, Paraproteinemias, Purpura, Parathyroid Cancer, Penile Cancer, Pheochromocytoma, Pituitary Tumor, Plasma Cell Neoplasm/Multiple Myeloma, Primary Central Nervous System Lymphoma, Primary Liver Cancer, Prostate Cancer, Rectal Cancer, Renal Cell Cancer, Renal Pelvis and Ureter Cancer, Retinoblastoma, Rhabdomyosarcoma, Salivary Gland Cancer, Sarcoidosis Sarcomas, Sezary Syndrome, Skin Cancer, Small Cell Lung Cancer, Small Intestine Cancer, Soft Tissue Sarcoma, Squamous Neck Cancer, Stomach Cancer, Supratentorial Primitive Neuroectodermal and Pineal Tumors, T-Cell Lymphoma, Testicular Cancer, Thymoma, Thyroid Cancer, Transitional Cell Cancer of the Renal Pelvis and Ureter, Transitional Renal Pelvis and Ureter Cancer, Trophoblastic Tumors, Ureter and Renal Pelvis Cell Cancer, Urethral Cancer, Uterine Cancer, Uterine Sarcoma, Vaginal Cancer, Visual Pathway and Hypothalamic Glioma, Vulvar Cancer, Waldenstrom's Macroglobulinemia, Wilms' Tumor, and any other hyperproliferative disease, besides neoplasia, located in an organ system listed above.

In some embodiments, the thawed encapsulated cells are used to treat a neurodegenerative disease, autoimmune disease (e.g., diabetes, multiple sclerosis, lupus, occlusions, capsular contractions), or a liver disease (e.g., hepatitis B infection, hepatitis C infection, cirrhosis, or liver cancer) in a subject. In some embodiments, the disease is diabetes (e.g., type 1 diabetes or type 2 diabetes). In some embodiments, the condition is fibrosis. In some embodiments, the condition is inflammation.

In some embodiments, the thawed encapsulated cells described herein may be used in a method to modulate (e.g., upregulate) the immune response in a subject. For example, upon administration to a subject, the thawed encapsulated cells (or an antigenic and/or therapeutic agent disposed within) may modulate (e.g., upregulate) the level of a component of the immune system in a subject (e.g., increasing the level or decreasing the level of an immune system component). Exemplary immune system components that may be modulated by the compositions provided for herein or related method described herein include stem cells (hematopoietic stem cells), NK cells, T cells (e.g., an adaptive T cell (e.g., a helper T cell, a cytotoxic T cell, memory T cell, or regulatory T cell) or an innate-like T cell (e.g., natural killer T cell, mucosal-associated invariant T cell, or gamma delta T cell), B cells, an antibody or fragment thereof, or other another component. In an embodiment, the modulation comprises increasing or decreasing the activation of a T cell or other immune system component (e.g., by about 5%, 10%, 15%, 20%, 25%, 30%, 35%, 40%, 45%, 50%, 55%, 60%, 65%. 70%, 75%, 80%, 85%, 90%, 95%, 99%, or more compared with a control).

The thawed encapsulated cells described herein may be used to modulate the immune response in a subject for a specific period of time. For example, administration of the thawed encapsulated cells (or an antigenic and/or therapeutic agent disposed within) may activate the immune response (e.g, by increase in the level of an immune system component) in a subject for at least 1 hour, 2 hours, 3 hours, 4 hours, 6 hours, 8 hours, 10 hours, 12 hours, 16 hours, 20 hours, 1 day, 1.5 days, 2 days, 3 days, 4 days, 5 days, 6 days, 1 week, 1.5 weeks, 2 weeks, 3 weeks, 4 weeks, 5 weeks, 6 weeks, 2 months, 2.5 months, 3 months, 4 months, 5 months, 6 months, or longer. In an embodiment, administration of the thawed encapsulated cells activates the immune response (e.g, by increase in the level of an immune system component) in a subject between 1 hour and 1 month, 1 hour and 3 weeks, 1 hour and 2 weeks, 1 hour and 1 week, 6 hours and 1 week, or 6 hours and 3 days. In an embodiment, implantation of the thawed encapsulated cells results in upregulation of T cells in a subject, e.g., as measured by a blood test, for at least 1 day.

The thawed encapsulated cells described herein may further comprise an additional pharmaceutical agent, such as an anti-proliferative agent, anti-cancer agent, anti-inflammatory agent, an immunomodulatory agent, or a pain-relieving agent, e.g., for use in combination therapy. The additional pharmaceutical agent may be disposed in or on the thawed encapsulated cells or may be produced by a cell disposed in or on the thawed encapsulated cells. In an embodiment, the additional pharmaceutical agent is small molecule, a protein, a peptide, a nucleic acid, an oligosaccharide, or other agent.

In an embodiment, the additional pharmaceutical agent is an anti-cancer agent. In some embodiments, the anti-cancer agent is a small molecule, a kinase inhibitor, an alkylating agent, a vascular disrupting agent, a microtubule targeting agent, a mitotic inhibitor, a topoisomerase inhibitor, an anti-angiogenic agent, or an anti-metabolite. In an embodiment, the anti-cancer agent is a taxane (e.g., paclitaxel, docetaxel, larotaxel or cabazitaxel). In an embodiment, the anti-cancer agent is an anthracy cline (e.g., doxorubicin). In some embodiments, the anti-cancer agent is a platinum-based agent (e.g., cisplatin or oxaliplatin). In some embodiments, the anti-cancer agent is a pyrimidine analog (e.g., gemcitabine). In some embodiments, the anti-cancer agent is chosen from camptothecin, irinotecan, rapamycin, FK506, 5-FU, leucovorin, or a combination thereof. In other embodiments, the anti-cancer agent is a protein biologic (e.g., an antibody molecule), or a nucleic acid therapy (e.g., an antisense or inhibitory double stranded RNA molecule).

In an embodiment, the additional pharmaceutical agent is an immunomodulatory agent, e.g, one or more of an activator of a costimulatory molecule, an inhibitor of an immune checkpoint molecule, or an anti-inflammatory agent. In an embodiment, the immunomodulatory agent is an inhibitor of an immune checkpoint molecule (e.g., an inhibitor of PD-1, PD-L1, LAG-3, TIM-3 or CTLA4, or any combination thereof). In some embodiments, the immunomodulatory agent is a cancer vaccine.

In some embodiments, the immunomodulatory agent is an inhibitor of PD-1, PD-L1, PD-L2, CTLA4, TIM3, LAG3, VISTA, BTLA, TIGIT, LAIRI, CD73, CD 160, 2B4 and/or TGFR beta. In one embodiment, the inhibitor of an immune checkpoint molecule inhibits PD-1, PD-L1, LAG-3, TIM-3 or CTLA4, or any combination thereof. Inhibition of an inhibitory molecule can be performed at the DNA, RNA or protein level. In some embodiments, an inhibitory nucleic acid (e.g., a dsRNA, siRNA or shRNA), can be used to inhibit expression of an inhibitory molecule. In other embodiments, the inhibitor of an inhibitory signal is, a polypeptide e.g., a soluble ligand (e.g., PD-1-Ig or CTLA-4 Ig), or an antibody or antigen binding fragment thereof, that binds to the inhibitory molecule; e.g., an antibody or fragment thereof that binds to PD-1, PD-L1, PD-L2, CTLA4, TIM3, LAG3, VISTA, BTLA, TIGIT, LAIRl, CD73, CD160, 2B4 and/or TGFR beta, or a combination thereof. In some embodiments, the immunomodulatory agent is an anti-inflammatory agent, e.g., an anti-inflammatory agent as described herein. In an embodiment, the anti-inflammatory agent is an agent that blocks, inhibits, or reduces inflammation or signaling from an inflammatory signaling pathway. In an embodiment, the anti-inflammatory agent inhibits or reduces the activity of one or more of any of the following an immune component of the subject. In an embodiment, the anti-inflammatory agent is an IL-1 or IL-1 receptor antagonist, such as anakinra, rilonacept, or canakinumab. In an embodiment, the anti-inflammatory agent is an

IL-6 or IL-6 receptor antagonist, e.g., an anti-IL-6 antibody or an anti-IL-6 receptor antibody, such as tocilizumab (ACTEMRA®), olokizumab, clazakizumab, sarilumab, sirukumab, siltuximab, or ALX-0061. In an embodiment, the anti-inflammatory agent is a TNF-a antagonist, e.g., an anti-TNF-a antibody, such as infliximab (REMICADE®), golimumab (SIMPONI®), adalimumab (HUMIRA®), certolizumab pegol (CIMZIA®) or etanercept. In one embodiment, the anti-inflammatory agent is a corticosteroid, e.g., as described herein.

The thawed encapsulated cells and a pharmaceutical composition thereof may be administered or implanted orally, parenterally (including subcutaneous, intramuscular, intravenous and intradermal), by inhalation spray, topically, rectally, nasally, buccally, vaginally or via an implanted reservoir. In some embodiments, provided compounds or compositions are administrable intravenously and/or orally. In some embodiments, the thawed encapsulated cells, or pharmaceutical composition thereof, are injected subcutaneously. In some embodiments, the thawed encapsulated cells, or pharmaceutical composition thereof, are injected into the intraperitoneal space. In some embodiments, the thawed encapsulated cells, or pharmaceutical composition thereof, are injected into the intraperitoneal space. In some embodiments, the thawed encapsulated cells, or pharmaceutical composition thereof, are delivered to the subject using a device, e.g., a cannula or catheter.

The term “parenteral” as used herein includes subcutaneous, intravenous, intramuscular, intraocular, intravitreal, intra-articular, intra-synovial, intrasternal, intrathecal, intrahepatic, intraperitoneal intralesional and intracranial injection or infusion techniques. Preferably, the compositions are administered orally, subcutaneously, intraperitoneally or intravenously. Sterile injectable forms of the compositions of this invention may be aqueous or oleaginous suspension. These suspensions may be formulated according to techniques known in the art using suitable dispersing or wetting agents and suspending agents. The sterile injectable preparation may also be a sterile injectable solution or suspension in a non-toxic parenterally acceptable diluent or solvent, for example as a solution in 1,3-butanediol. Among the acceptable vehicles and solvents that may be employed are water, Ringer's solution and isotonic sodium chloride solution. In addition, sterile, fixed oils are conventionally employed as a solvent or suspending medium.

For ophthalmic use, provided compounds, compositions, and devices may be formulated as micronized suspensions or in an ointment such as petrolatum.

In an embodiment, the release of an antigenic, therapeutic, or additional pharmaceutical agent is released in a sustained fashion. In order to prolong the effect of a particular agent, it is often desirable to slow the absorption of the agent from injection. This can be accomplished by the use of a liquid suspension of crystalline or amorphous material with poor water solubility. The rate of absorption of the agent then depends upon its rate of dissolution which, in turn, may depend upon crystal size and crystalline form. Alternatively, delayed absorption of a parenterally administered drug form is accomplished by dissolving or suspending the drug in an oil vehicle.

Although the descriptions of pharmaceutical compositions provided herein are principally directed to pharmaceutical compositions which are suitable for administration to humans, it will be understood by the skilled artisan that such compositions are generally suitable for administration to animals of all sorts. Modification of pharmaceutical compositions suitable for administration to humans in order to render the compositions suitable for administration to various animals is well understood, and the ordinarily skilled veterinary pharmacologist can design and/or perform such modification with ordinary experimentation.

The thawed encapsulated cells, or pharmaceutical composition thereof, provided herein are typically formulated in dosage unit form, e.g., single unit dosage form, for ease of administration and uniformity of dosage. It will be understood, however, that the total daily usage of the compositions of the present invention will be decided by the attending physician within the scope of sound medical judgment. The specific therapeutically effective dose level for any particular subject or organism will depend upon a variety of factors including the disease being treated and the severity of the disorder; the activity of the specific active ingredient employed; the specific composition employed; the age, body weight, general health, sex and diet of the subject; the time of administration, route of administration, and rate of excretion of the specific active ingredient employed; the duration of the treatment; drugs used in combination or coincidental with the specific therapeutic agent employed; and like factors well known in the medical arts.

The exact amount of a compound required to achieve an effective amount will vary from subject to subject, depending, for example, on species, age, and general condition of a subject, severity of the side effects or disorder, identity of the particular compound(s), mode of administration, and the like. The desired dosage can be delivered three times a day, two times a day, once a day, every other day, every third day, every week, every two weeks, every three weeks, or every four weeks. In certain embodiments, the desired dosage can be delivered using multiple administrations (e.g, two, three, four, five, six, seven, eight, nine, ten, eleven, twelve, thirteen, fourteen, or more administrations).

An effective amount of a therapeutic agent released from the In some embodiments, the thawed encapsulated cells, or pharmaceutical composition thereof, may comprise about 0.0001 mg to about 3000 mg, about 0.0001 mg to about 2000 mg, about 0.0001 mg to about 1000 mg, about 0.001 mg to about 1000 mg, about 0.01 mg to about 1000 mg, about 0.1 mg to about 1000 mg, about 1 mg to about 1000 mg, about 1 mg to about 100 mg, about 10 mg to about 1000 mg, or about 100 mg to about 1000 mg, of therapeutic agent per unit dosage form (e.g, per composition of thawed encapsulated cells, or pharmaceutical composition thereof).

The therapeutic agent administered may be at dosage levels sufficient to deliver from about 0.001 mg/kg to about 100 mg/kg, from about 0.01 mg/kg to about 50 mg/kg, preferably from about 0.1 mg/kg to about 40 mg/kg, preferably from about 0.5 mg/kg to about 30 mg/kg, from about 0.01 mg/kg to about 10 mg/kg, from about 0.1 mg/kg to about 10 mg/kg, and more preferably from about 1 mg/kg to about 25 mg/kg, of subject body weight per day, one or more times a day, to obtain the desired therapeutic effect.

In addition, in some embodiments, the following embodiments are provided:

1. A method of cryopreserving or freezing a population of encapsulated cells comprising a plurality of oligonucleotide molecules encoding a heterologous molecule, such as an immune effector, the method comprising:
contacting the encapsulated cells in a container with an effective amount of a cryopreservation media to form cryopreservation composition, wherein the cryopreservation media comprises at least 5-12% dimethylsulfoxide (DMSO) and at least one other component;
incubating the container comprising the cryopreservation composition at room temperature (e.g. 20-25° C.); and
cooling the incubated container comprising the cryopreservation composition at rate of 1-5° C. to a temperature sufficient to cryopreserve the encapsulated cells.
   2. The method of embodiment 1, wherein the at least one other component is propylene glycol, ethylene glycol, or polyethylene glycol.
   3. The method of embodiment 1, wherein the cryopreservation media comprises BAMBANKER™, BAMBANKER™ HRM, CryoStor® CS10, CryoStor® CS5, CTS™ Synth-a-Freeze™, human serum albumin (HAS), glycerol, propylene glycol (PG), ethylene glycol (EG), polyethylene glycol (PEG), and any combination thereof.
   3. The method of embodiment 2, wherein the cryopreservation media comprises about 0.1%-99% of BAMBANKER™, BAMBANKER™HRM, CryoStor® CS10, CryoStor® CS5, CTS™ Synth-a-Freeze™, glycerol, propylene glycol (PG), ethylene glycol (EG), dimethyl sulfoxide (DMSO), polyethylene glycol (PEG), and any combination thereof, in basal media.
   4. The method of embodiments 1-3, wherein the cryopreservation media is added to the population of encapsulated cells at a ratio of about 50 mL, about 40 mL, about 30 mL, about 20 mL, about 10 mL, about 9 mL, about 8 mL, about 7 mL, about 8 mL, about 6 mL, about 5 mL, about 4 mL, about 3 mL, about 2 mL, about 1 mL, about 0.5 mL, or about 0.1 mL of the cryopreservation media to about 1 mL of the population of encapsulated cells.
   5. The method of embodiment 4, wherein the cryopreservation media is added to the population of encapsulated cells at a ratio of about 1 mL of the cryopreservation media to about 1 mL of the population of encapsulated cells.
   6. The method of any one of embodiment 1-5, wherein the cryopreservation composition is incubated at room temperature for about 1 to about 10 minutes, about 5 to about 15 minutes, about 10 minutes, 15 minutes, about 20 minutes, about 25 minutes, about 30 minutes, about 35 minutes, about 40 minutes, about 45 minutes, about 50 minutes, about 55 minutes, or about 60 minutes prior to cooling.
   7. The method of any one of embodiments 1-6, wherein the temperature sufficient to cryopreserve the encapsulated cells is about −70° C. to about −200° C.
   8. The method of any one of embodiments 1-17, wherein the cooling container comprises placing the container in an ethanol solution and in a freezer that is at a temperature from about −70° C. to about −200° C.
   9. The method of any one of embodiments 1-8, wherein the cryopreservation media comprises a sugar.
   10. The method of embodiment 9, wherein the sugar is trehalose, mannose, sucrose, or any combination thereof.
   11. The method of any one of embodiments 1-8, wherein the cryopreservation media does not comprise a sugar.
   12. The method of any one of embodiments 1-11, wherein the cryopreservation media comprises plasmalyte.
   13. The method of any one of embodiments 1-11, wherein the cryopreservation media does not comprise plasmalyte.
   14. The method of any one of embodiments 1-13, wherein the encapsulated cells retain about 10 to about 40% viability, about 40% to about 70% viability, at least 40% viability, at least 50% viability, at least 60% viability, at least 70% viability, at least 80% viability, or at least 90% viability after being frozen in the cryopreservation media for about, or at least, 1 day, 1 week, 1 month, 2 months, 3 months, 4 months, 5 months, 6 months, 9 months, or 12 months.
   15. The method of any one of embodiments 1-14, wherein the encapsulated cells have a diameter of about 1 to about 2 mm, about 1 mm, about 1.5 mm, or about 2 mm.
   16. The method of any one of embodiments 1-15, wherein the heterologous molecule is an antigen molecule, wherein the antigen molecule can induce an immune response in a subject, 17. The method of any one of embodiments 1-16, wherein the heterologous molecule comprises a nucleic acid, a protein, an antibody, antibody fragment, enzyme, cytokine, hormone, receptor, a lipid, a small molecule, a metabolic agent, an oligosaccharide, a peptide, or an amino acid.
   18. The method of any one of embodiments 1-17, wherein the heterologous molecule, such as an immune effector molecule, activates an immune cell in a subject, represses an immune cell in a subject, and/or modulates immune cell migration in a subject.
   19. The method of any one of embodiments 1-18, wherein the heterologous molecule, such as an immune effector molecule, molecule enhances an immune response in a subject.
   20. The method of any of embodiments 1-19, wherein the heterologous molecule, such as an immune effector molecule, molecule modulates host dendritic cell migration and/or host T cell activation 21. The method of any one of embodiments 1-20, wherein the heterologous molecule, such as an immune effector molecule, enhances the immune response to the heterologous molecule.
   22. The method of embodiment 21, wherein the enhancing is specific for the heterologous molecule.
   23. The method of any one of embodiments 1-22, wherein the heterologous molecule comprises an exogenous antigen, endogenous antigen, autoantigen, neoantigen, viral antigen, or tumor antigen.
   24. The method of any one of embodiments 1-23, wherein the heterologous molecule, such as an immune effector molecule, is a cytokine.
   25. The method of embodiment 24, wherein the cytokine is selected from IL-2, IL-12, IL-1, IL-1α, IL-1β, IL-1RA, IL-4, IL-5, IL-6, IL-7, IL-8, IL-9, IL-10, IL-11, IL-12a, IL-12b, IL-13, IL-14, IL-16, IL-17, G-CSF, GM-CSF, IL-20, IFN-α, IFN-β, IFN-γ, CD154, LT-0, CD70, CD153, CD178, TRAIL, TNF-α, TNF-β, SCF, M-CSF, MSP, 4-1BBL, LIF, and OSM.
   26. The method of embodiment 24, wherein the cytokine is selected from IL-2, IL-12a, IL-12b, IL-4, IL-7, IL-10, and IL-17.
   27. The method of any one of embodiments 1-26, wherein the cells are as provided herein.
   28. The method of any one of embodiments 1-27, wherein the cells are ARPE-19 cells, ARPE-19-SEAP-2-neo cells, RPE-J cells, hTERT RPE-1 cells, or any combination thereof.
   29. The method of any one of embodiments 1-28, wherein the cells are encapsulated with a polymeric hydrogel.
   30. The method of any one of embodiments 1-29, wherein the polymeric hydrogel comprises chitosan, cellulose, hyaluronic acid, or alginate.
   31. The method of any one of embodiments 1-30, wherein the polymeric hydrogel comprises alginate.
   32. The method of any one of embodiments 1-31, wherein the alginate comprises SLG20, VLVG (very low viscosity alginate), LVG (low viscosity alginate), MVG (medium viscosity alignate), or SLG100.
   33. The method of embodiment 32, wherein the SLG20 is about 0.1%-3% SLG20.
   34. The method of any one of embodiments 1-33, wherein the cells remain viable for at least 5, 10, 15, 20, 40, or 180 days.
   35. The method of any one of embodiments 1-34, wherein the encapsulated cells do not proliferate.
   36. The method of any one of embodiments 1-35, wherein the encapsulated cells show no fibrotic overgrowth over time after implantation in a subject.
   37. The method of any one of embodiments 1-36, wherein the encapsulated cells show small fibrotic overgrowth over time after implantation in a subject.
   38. A method of maintaining viability of a population of encapsulated cells, the method comprising the steps of:
adding an effective amount of a cryopreservation media to a container comprising the population of encapsulated cells to form a contain comprising a cryopreservation composition, wherein the cryopreservation media comprises at least 5-12% dimethylsulfoxide (DMSO) and at least one other component;
incubating the container comprising the cryopreservation composition at room temperature (e.g. 20-25° C.) prior to cooling;
cooling the container comprising the cryopreservation composition at rate of 1-5° C. to a temperature sufficient to cryopreserve the cells;
maintaining the container comprising the cryopreservation composition at a temperature sufficient to cryopreserve the cells; and
thawing the cryopreservation composition under conditions sufficient to maintain viability of the population of encapsulated cells.
   39. The method of embodiment 38, wherein the at least one other component is propylene glycol, ethylene glycol, or polyethylene glycol.
   40. The method of embodiment 39, wherein the cryopreservation media is selected from BAMBANKER™, CryoStor® CS10, CryoStor® CS5, CTS™ Synth-a-Freeze™, glycerol, propylene glycol (PG), ethylene glycol (EG), dimethyl sulfoxide (DMSO), polyethylene glycol (PEG), and any combination thereof.
   41. The method of embodiment 40, wherein the cryopreservation media comprises about 0.1%-99% of BAMBANKER™, CryoStor® CS10, CryoStor® CS5, CTS™ Synth-a-Freeze™, glycerol, propylene glycol (PG), ethylene glycol (EG), dimethyl sulfoxide (DMSO), polyethylene glycol (PEG), and any combination thereof, in basal media.
   42. The method of embodiments 39-41, wherein the cryopreservation media is added to the population of encapsulated cells at a ratio of about 50 mL, about 40 mL, about 30 mL, about 20 mL, about 10 mL, about 9 mL, about 8 mL, about 7 mL, about 8 mL, about 6 mL, about 5 mL, about 4 mL, about 3 mL, about 2 mL, about 1 mL, about 0.5 mL, or about 0.1 mL of the cryopreservation media to about 1 mL of the population of encapsulated cells.
   43. The method of embodiment 42, wherein the cryopreservation media is added to the population of encapsulated cells at a ratio of about 1 mL of the cryopreservation media to about 1 mL of the population of encapsulated cells.
   44. The method of embodiments 39-43, wherein cryopreservation composition is incubated at room temperature for about 1 to about 10 minutes, about 5 to about 15 minutes, about 10 minutes, 15 minutes, about 20 minutes, about 25 minutes, about 30 minutes, about 35 minutes, about 40 minutes, about 45 minutes, about 50 minutes, about 55 minutes, or about 60 minutes prior to cooling.
   45. The method of any one of embodiments 39-44, wherein the temperature sufficient to cryopreserve the encapsulated cells is about −70° C. to about −200° C.
   46. The method of any one of embodiments 39-45, wherein the temperature sufficient to maintain viability of the population of encapsulated cells is about −70° C. to about −200° C.
   47. The method of any one of embodiments 39-46, wherein the cooling container comprises placing the container in an ethanol solution and in a freezer that is at a temperature from about −70° C. to about −200° C.
   48. The method of any one of embodiments 39-47, wherein the cryopreservation media comprises a sugar.
   49. The method of embodiment 48, wherein the sugar is trehalose, mannose, sucrose, or any combination thereof.
   50. The method of any one of embodiments 39-47, wherein the cryopreservation media does not comprise a sugar.
   51. The method of any one of embodiments 39-50, wherein the cryopreservation media comprises plasmalyte.
   52. The method of any one of embodiments 39-50, wherein the cryopreservation media does not comprise plasmalyte.
   53. The method of any one of embodiments 39-52, wherein the encapsulated cells retain about 10 to about 40% viability, about 40% to about 70% viability, at least 40% viability, at least 50% viability, at least 60% viability, at least 70% viability, at least 80% viability, or at least 90% viability after being frozen in the cryopreservation media for about, or at least, 1 day, 1 week, 1 month, 2 months, 3 months, 4 months, 5 months, 6 months, 9 months, or 12 months.
   54. The method of any one of embodiments 39-53, wherein the encapsulated cells have a diameter of about 1 to about 2 mm, about 1 mm, about 1.5 mm, or about 2 mm.
   55. The method of any one of embodiments 39-54, wherein the thawing comprises the steps of:
thawing the cryopreservation composition;
washing the population of encapsulated cells; and
replacing the cryopreservation media with basal media.
   56. The method of embodiment 55, wherein the thawing step comprises thawing the cryopreservation composition using a water bath or a controlled thawing device.
   57. The method of embodiment 56, wherein the water bath is at a temperature of about 15° C. to about 40° C.
   58. The method of embodiment 57, wherein the water bath is at a temperature of about 37° C.
   59. The method of embodiment 55, wherein the washing step comprises the steps of:
mixing the cryopreservation composition with thawing media to form a thawing composition;
agitating the thawing composition on a tube rotator; or/and
centrifuging the thawing composition.
   60. The method of embodiment 59, wherein the thawing media comprises Cell Thawing Media 10% Dextran 40 (in 0.9% NaCl), Cell Thawing Media 10% Dextran 40 (in 5% Dextrose), DMEM, DMEM/F12, RPMI, ethylene glycol (EG), dimethyl sulfoxide (DMSP), sucrose, and any combination thereof.
   61. The method of embodiments 59 or 60, wherein the thawing media comprises about 0.1%-99% Cell Thawing Media 10% Dextran 40 (in 0.9% NaCl), Cell Thawing Media 10% Dextran 40 (in 5% Dextrose), DMEM, DMEM/F12, RPMI, ethylene glycol (EG), dimethyl sulfoxide (DMSP), sucrose, and any combination thereof.
   62. The method of embodiments 59-62, wherein the cryopreservation composition is mixed with the thawing media at a ratio of about 1 mL of the cryopreservation composition to about 100 mL, about 90 mL, about 80 mL, about 70 mL, about 60 mL, about 50 mL, about 40 mL, about 30 mL, about 20 mL, about 15 mL, about 10 mL, about 5 mL, or about 1 mL of thawing media.
   63. The method of embodiment 62, wherein the agitating step comprises rotating the population of cells on a tube rotator at a rate of 30 rotations per minute for about 60 minutes, about 50 minutes, about 45 minutes, about 40 minutes, about 35 minutes, about 30 minutes, about 25 minutes, about 20 minutes, about 15 minutes, about 10 minutes, or about 5 minutes.
   64. The method of any one of embodiments 59-63, wherein the centrifuging step comprises centrifuging the population of encapsulated cells at a rate of about 1000, about 900, about 800, about 700, about 600, about 500, about 400, about 300, about 200, or about 100 rotations per minute for about 3 minutes.
   65. The method of any one of embodiments 55-64, wherein the basal media is selected from DMEM, DMEM/F12, DMEM/F12+10% FBS, RPMI, or media containing about 0-15% human albumin.
   66. The method of any one of embodiments 30-48, wherein the population of encapsulated cells has a post-thawing viability of about 10 to about 40% viability, about 40% to about 70% viability, at least 40% viability, at least 50% viability, at least 60% viability, at least 70% viability, at least 80% viability, or at least 90% viability after being frozen in the cryopreservation media for about, or at least, 1 day, 1 week, 1 month, 2 months, 3 months, 4 months, 5 months, 6 months, 9 months, or 12 months.
   67. The method of any one of embodiments 39-66, wherein the cells are as provided herein.
   68. The method of any one of embodiments 39-66, wherein the cells are ARPE-19 cells, ARPE-19-SEAP-2-neo cells, RPE-J cells, hTERT RPE-1 cells, or any combination thereof.
   69. The method of any one of embodiments 39-68, wherein the cells are encapsulated with a polymeric hydrogel.
   70. The method of embodiment 69, wherein the polymeric hydrogel comprises chitosan, cellulose, hyaluronic acid, or alginate.
   71. The method of embodiment 69, wherein the polymeric hydrogel comprises alginate.
   72. The method of embodiment 71, wherein the alginate comprises SLG20, VLVG (very low viscosity alginate), LVG (low viscosity alginate), MVG (medium viscosity alignate), or SLG100.
   73. The method of embodiment 72, wherein the SLG20 is about 0.1%-3% SLG20.
   74. The method of any one of embodiments 39-73, wherein the encapsulated cells do not proliferate.
   75. A method of thawing a cryopreserved composition comprising a plurality of encapsulated cells, wherein the cryopreservation composition is prepared according to a method of any one of embodiments 1-74, wherein the thawing comprises the steps of:
thawing the cryopreservation composition;
washing the population of encapsulated cells; and
replacing the cryopreservation media with basal media.
   76. The method of embodiment 75, wherein the thawing step comprises thawing the cryopreservation composition in a water bath or a controlled thawing device.
   77. The method of embodiment 76, wherein the water bath is at a temperature of about 15° C. to about 40° C.
   78. The method of embodiment 77, wherein the water bath is at a temperature of about 37° C.
   79. The method of embodiment 75, wherein the washing step comprises the steps of:
mixing the cryopreservation composition with thawing media to form a thawing composition;
agitating the thawing composition on a tube rotator; or/and
centrifuging the thawing composition.
   80. The method of embodiment 75, wherein the thawing media comprises Cell Thawing Media 10% Dextran 40 (in 0.9% NaCl), Cell Thawing Media 10% Dextran 40 (in 5% Dextrose), DMEM, DMEM/F12, RPMI, ethylene glycol (EG), dimethyl sulfoxide (DMSO), and any combination thereof.
   81. The method of embodiment 75, wherein the thawing media comprises about 0.1%-99% of Cell Thawing Media 10% Dextran 40 (in 0.9% NaCl), Cell Thawing Media 10% Dextran (in 5% Dextrose), DMEM, DMEM/F12, RPMI, ethylene glycol (EG), dimethyl sulfoxide (DMSO), and any combination thereof.
   82. The method of any one of embodiments 75-81, wherein the cryopreservation composition is mixed with the thawing media at a ratio of about 1 mL of the cryopreservation composition to about 100 mL, about 90 mL, about 80 mL, about 70 mL, about 60 mL, about 50 mL, about 40 mL, about 30 mL, about 20 mL, about 15 mL, about 10 mL, about 5 mL, or about 1 mL of thawing media.
   83. The method of any one of embodiments 75-82, wherein the agitating step comprises rotating the population of cells on a tube rotator at a rate of 30 rotations per minute for about 60 minutes, about 50 minutes, about 45 minutes, about 40 minutes, about 35 minutes, about 30 minutes, about 25 minutes, about 20 minutes, about 15 minutes, about 10 minutes, or about 5 minutes.
   84. The method of any one of embodiments 75-83, wherein the centrifuging step comprises centrifuging the population of encapsulated cells at a rate of about 1000, about 900, about 800, about 700, about 600, about 500, about 400, about 300, about 200, or about 100 rotations per minute for about 3 minutes.
   85. The method of any one of embodiments 75-84, wherein the basal media is selected from DMEM, DMEM/F12, DMEM/F12+10% FBS, RPMI, or media containing about 0-15% human albumin.
   86. The method of any one of embodiments 75-85, wherein the population of encapsulated cells has a post-thawing viability of about 10 to about 40% viability, about 40% to about 70% viability, at least 40% viability, at least 50% viability, at least 60% viability, at least 70% viability, at least 80% viability, or at least 90% viability after being frozen in the cryopreservation media for about, or at least, 1 day, 1 week, 1 month, 2 months, 3 months, 4 months, 5 months, 6 months, 9 months, or 12 months.
   87. A frozen or thawed composition preparing according to a method of any one of embodiments 1-73.
   88. A composition comprising encapsulated cells at least 5-12% dimethylsulfoxide (DMSO) and at least one other component, wherein the encapsulated cells optionally comprise a nucleic acid molecule encoding a heterologous molecule, such as an immune effector molecule.
   89. The composition of embodiment 75, wherein the at least one other component is polyethylene glycol, propylene glycol (PG), or ethylene glycol (EG).
   90. The composition of embodiments 88 or 89, wherein the composition comprises BAMBANKER™, CryoStor® CS10, CryoStor® CS5, CTS™ Synth-a-Freeze™, human serum albumin (HAS), glycerol, propylene glycol (PG), ethylene glycol (EG), polyethylene glycol (PEG), and any combination thereof.
   91. The composition of embodiments 88 or 89, wherein the cryopreservation media comprises about 0.1%-99% of BAMBANKER™, CryoStor® CS10, CryoStor® CS5, CTS™ Synth-a-Freeze™, glycerol, propylene glycol (PG), ethylene glycol (EG), dimethyl sulfoxide (DMSO), polyethylene glycol (PEG), and any combination thereof, in basal media.
   92. The composition of any one of embodiments 88-91, wherein the encapsulated cells have a capsule diameter of about 1 mm to about 2 mm, about 1 mm, about 1.5 mm, or about 2 mm.
   93. The composition of any one of embodiments 88-92, wherein the heterologous molecule is an antigen molecule, wherein the antigen molecule can induce an immune response in a subject,
   94. The composition of any one of embodiments 88-93, wherein the heterologous molecule comprises a nucleic acid, a protein, an antibody, antibody fragment, enzyme, cytokine, hormone, receptor, a lipid, a small molecule, a metabolic agent, an oligosaccharide, a peptide, or an amino acid.
   95. The composition of any one of embodiments 88-94, wherein the heterologous molecule, such as an immune effector molecule, activates an immune cell in a subject, represses an immune cell in a subject, and/or modulates immune cell migration in a subject.
   96. The composition of any one of embodiments 88-95, wherein the heterologous molecule, such as an immune effector molecule, molecule enhances an immune response in a subject.
   97. The composition of any one of embodiments 88-96, wherein the heterologous molecule, such as an immune effector molecule, molecule modulates host dendritic cell migration and/or host T cell activation
   98. The composition of any one of embodiments 88-97, wherein the heterologous molecule, such as an immune effector molecule, enhances the immune response to the heterologous molecule.
   99. The composition of any one of embodiments 88-98, wherein the enhancing is specific for the heterologous molecule.
   100. The composition of any one of embodiments 88-99, wherein the heterologous molecule comprises an exogenous antigen, endogenous antigen, autoantigen, neoantigen, viral antigen, or tumor antigen.
   101. The composition of any one of embodiments 88-100, wherein the heterologous molecule, such as an immune effector molecule, is a cytokine.
   102. The composition of embodiment 101, wherein the cytokine is selected from IL-2, IL-12, IL-1, IL-1α, IL-1β, IL-iRA, IL-4, IL-5, IL-6, IL-7, IL-8, IL-9, IL-10, IL-11, IL-12a, IL-12b, IL-13, IL-14, IL-16, IL-17, G-CSF, GM-CSF, IL-20, IFN-α, IFN-β, IFN-γ, CD154, LT-3, CD70, CD153, CD178, TRAIL, TNF-α, TNF-β, SCF, M-CSF, MSP, 4-1BBL, LIF, and OSM.
   103. The composition of embodiment 101, wherein the cytokine is selected from IL-2, IL-12a, IL-12b, IL-4, IL-7, IL-10, and IL-17.
   104. The composition of any one of embodiments 88-103, wherein the cells are ARPE-19 cells, ARPE-19-SEAP-2-neo cells, RPE-J cells, hTERT RPE-1 cells, or any combination thereof.
   105. The composition of any one of embodiments 88-104, wherein the cells are encapsulated with a polymeric hydrogel.
   106. The composition of embodiment 105, wherein the polymeric hydrogel comprises chitosan, cellulose, hyaluronic acid, or alginate.
   107. The composition of embodiment 106, wherein the polymeric hydrogel comprises alginate.
   108. The composition of embodiment 107, wherein the alginate comprises SLG20, VLVG (very low viscosity alginate), LVG (low viscosity alginate), MVG (medium viscosity alignate), or SLG100.
   109. The composition of embodiment 108, wherein the SLG20 is about 0.1%-3% SLG20.
   110. A method of treating a subject with a disease or condition, the method comprising thawing a cryopreserved composition preparing according to any one of 1-74 and administering the thawed encapsulated cells to the subject.
   111. The method of embodiment 110, wherein the thawing is performed according to a method of any one of embodiments 75-86.
   112. The method of embodiments 110 or 111, wherein the subject has cancer.

### G. Examples

The following examples are included to demonstrate preferred embodiments. It should be appreciated by those of skill in the art that the techniques disclosed in the examples that follow represent techniques discovered by the inventor to function well in the practice of embodiments, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the disclosure.

Example 1: Encapsulation of Cells. Polyclonal ARPE-19 cells were expanded and transfected using a lipofectamine protocol with a ratio of 5:1 (transposase:transposon) to create cells expressing human native IL-12. Transfected cells were cultured are plated at 0.5 cells/well for single cell outgrowth. IL-12 production of the selected clone was about ˜3.8 PCD (picograms/cell/day). The clone was expanded in cell flasks/stacks for up to two weeks before being harvested into a cell pellet and suspended in alginate (SLG20) for encapsulation. The encapsulation process comprises loading two syringes, one with SLG20, and one with the cell pellet (42 million cells/mL) suspended in alginate (SLG20). The syringes were fed into a coaxial needle through use of a power supply (electric current) allowing droplets to fall into a crosslinking bath, which contained mannitol, barium chloride, HEPES buffer and Tween 20, which was where the capsules take shape. Capsules were collected from the bath after sitting in the bath for 5 minutes and washed 8 times at a 1:25 ratio of capsules to HEPES buffer solution (2 minutes/wash) to help to help remove loosely bound barium. The encapsulated cells were stored in DMEM/F12 cell culture media at ambient temperature in biotainer bottle.

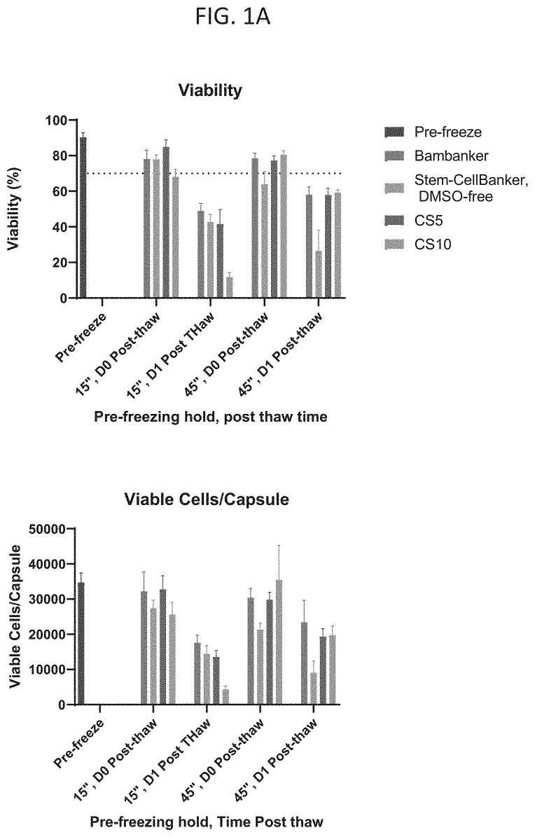

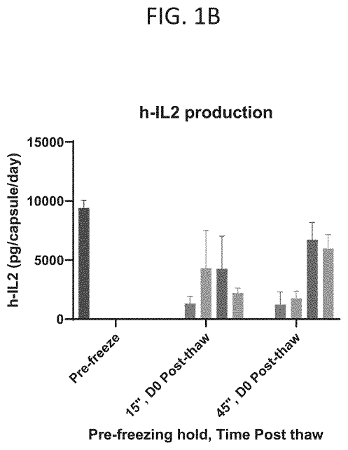

Example 2: Cryopreservation of Encapsulated Cells. Using sterile 1.5 mL microcentrifuge tubes, 8 aliquots containing the volume of 0.5 mL of encapsulated cells in DMEM/F12 were made. Excess DMEM/F12 was removed from each aliquot. A volume of 1.0 mL of BAMBANKER™ (BulldogBio, P/N: BB01; without DMF; used as control), CryoStor® CS10 (BioLife Solutions, P/N: 07930), CryoStor® CS5 (BioLife Solutions, P/N: 205373), or STEM-CELLBANKER® (Cat #11890; DMSO-free) cryopreservative was added to each tube and aliquots were mixed approximately every 5 minutes. Tubes comprising encapsulated cells and the cryopreservative media were allowed to equilibrate for a period of 15 minutes or 45 minutes at room temperature. Following incubation, tubes were frozen at −80° C. Encapsulated cells were frozen at a cellular density of approximately 5.2e6 cells/mL of cryopreservative. Encapsulated cells were frozen for 1 week prior to thawing. Viability and antigen production were evaluated for each condition, and are as shown in FIGS. 1A and 1B. BAMBANKER™ (BulldogBio, P/N: BB01; without DMF; used as control), CryoStor® CS10 (BioLife Solutions, P/N: 07930), and CryoStor® CS5 (BioLife Solutions, P/N: 205373) allowed viabilities of greater than 70% post-thawing, but not STEM-CELLBANKER® (Cat #11890; DMSO free). Accordingly, BAMBANKER™ (BulldogBio, P/N: BB01; without DMF; used as control), CryoStor® CS10 (BioLife Solutions, P/N: 07930), and CryoStor® CS5 (BioLife Solutions, P/N: 205373) maintain viability of encapsulated cells.

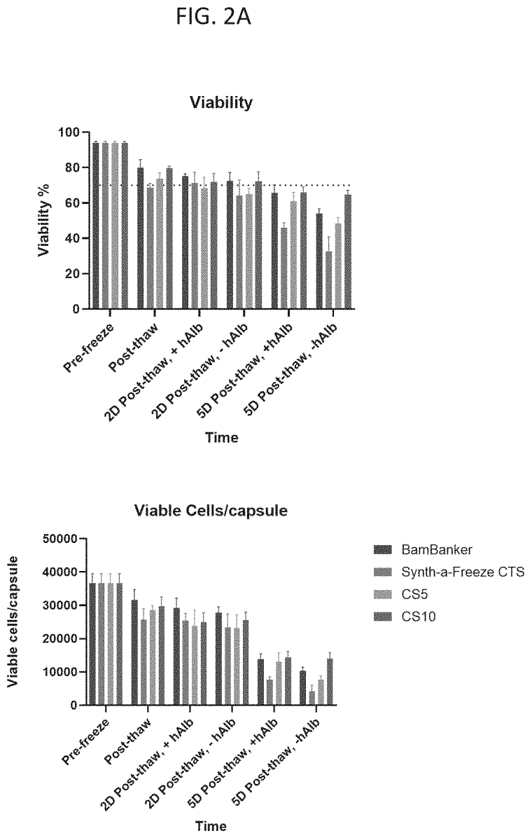

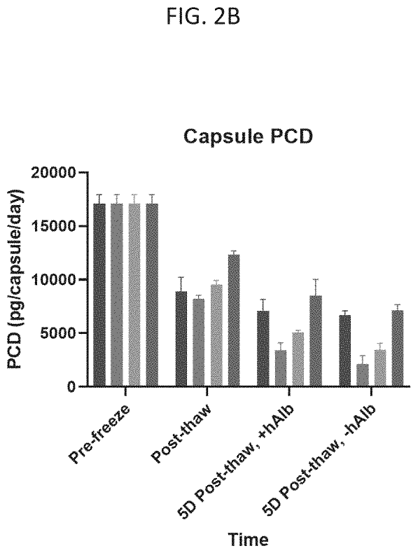

Example 3: Cryopreservation of Encapsulated Cells. Using sterile 2 mL cryovials, 4 aliquots containing the volume of 4 mL of encapsulated cells in DMEM/F12 were made. Excess DMEM/F12 was removed from each aliquot. A volume of 1 mL of BAMBANKER™ (BulldogBio, P/N: BB01; without DMF; used as control), CTS™ Synth-a-Freeze™ (ThermoFisher, P/N: A1371301), CryoStor® CS10 (BioLife Solutions, P/N: 07930), or CryoStor® CS5 (BioLife Solutions, P/N: 205373) cryopreservative was added per 1 mL of capsules to each cryovial and aliquots were mixed approximately every 5 minutes. Cryovials comprising encapsulated cells and the cryopreservative media were allowed to equilibrate for a period of 45 minutes at room temperature. Following incubation, tubes were frozen at −80° C. Encapsulated cells were frozen for 1 week prior to thawing. Encapsulated cells were thawed in a 37° C. water bath. Once ice crystals were no longer visible, encapsulated cells were aspirated and added to 15 mL conical tube containing 15 mL of thawing buffer (BioLife Solutions, PN:980203 Lot: 20047). The solution was washed on tube rotator for 10 minutes at 30 RPM. Following washing, encapsulated cells were centrifudged at 600 G for 3 minutes. Following centrifugation, the thawing buffer was aspirated and 10 mL of fresh thawing buffer was added to each tube and the encapsulated cells were transferred to 6-well plate for analysis and storage. Following sampling for analysis, 2 aliquots of 0.5 mL were made for each thawed vial. Aliquots were then transferred to 50 mL PETG bottles containing either DMEM/F12 or DMEM/F12 supplemented with 2.5 mg/mL human Albumin. Viability and antigen production were evaluated for each condition, and are shown in FIGS. 2A and 2B. BAMBANKER™ (BulldogBio, P/N: BB01; without DMF; used as control), CryoStor® CS10 (BioLife Solutions, P/N: 07930), and CryoStor® CS5 (BioLife Solutions, P/N: 205373) allowed viabilities of greater than 70% post-thawing, but not CTS™ Synth-a-Freeze™ (ThermoFisher, P/N: A1371301). Furthermore, samples containing hAlb showed improved viability as shown in FIG. 2A. Normalized antigen production showed slight drop in IL-2 production post-thawing with recovery by day 5, as shown in FIG. 2B. Accordingly, BAMBANKER™ (BulldogBio, P/N: BB01; without DMF; used as control), CryoStor® CS10 (BioLife Solutions, P/N: 07930), and CryoStor® CS5 (BioLife Solutions, P/N: 205373) maintain viability of encapsulated cells.

Example 4: Cryopreservation of Encapsulated Cells. Using sterile cryovials, 6 aliquots containing the volume of 1 mL of encapsulated cells in DMEM/F12 were made. Excess DMEM/F12 was removed from each aliquot. A volume of 1 mL of BAMBANKER™ (BulldogBio, P/N: BB01; without DMF; used as control), or CryoStor® CS10 (BioLife Solutions, P/N: 07930) cryopreservative was added to each cryovial and aliquots were mixed approximately every 5 minutes. Cryovials comprising encapsulated cells and the cryopreservative media were allowed to equilibrate for a period of 45 minutes at room temperature. Following incubation, tubes were frozen at −₈₀° C. Encapsulated cells were frozen for at least one week prior to thawing. Encapsulated cells were thawed using one of the three different thaw conditions.

Thaw Condition 1: The vial was thawed using a water bath at a temperature of 37° C. until no ice was observed. Next, contents of the cryovial were transferred to a 50 mL conical tube containing 10 mL of BioLife Solutions Cell Thawing Media (Cell Thawing Media 10% Dextran 40 (in 0.09% NaCl), P/N: 980203). Encapsulated cells were then washed using a tube rotator at a rate of 30 RPM for 10 minutes. Following the wash, encapsulated cells were centrifuged at a rate of 600 RPM for 3 minutes. Media was aspirated and replaced with 25 mL of DMEM/F12 (11039-021, lot:2193308).

Thaw Condition 2: The vial was thawed using a water bath at a temperature of 37° C. until no ice was observed. Next, contents of the cryovial were transferred to a 50 mL conical tube containing 50 mL of DMEM/F12 media (11039-021, lot:2193308). Encapsulated cells were then centrifuged at a rate of 600 RPM for 3 minutes. Media was aspirated and replaced with 25 mL of DMEM/F12 ((11039-021, lot:2193308).

Thaw Condition 3: The vial was thawed using a water bath at a temperature of 37° C. until no ice was observed. Next, contents of the cryovial were transferred to a 50 mL conical tube containing 50 mL of DMEM/F12 media (11039-021, lot:2193308). Encapsulated cells were washed using a tube rotator at a rate of 30 RPM for 30 minutes. Capsules were then centrifuged at a rate of 600 RPM for 3 minutes. Media was aspirated and replaced with 25 mL of DMEM/F12 (11039-021, lot:2193308).

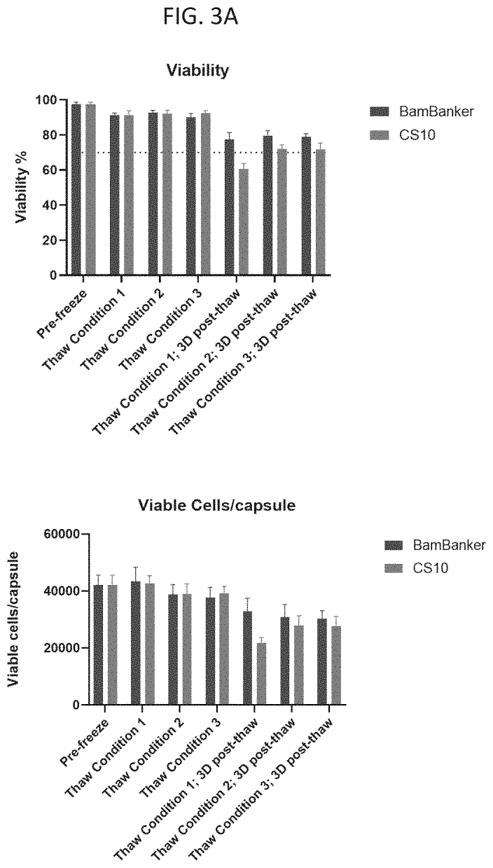

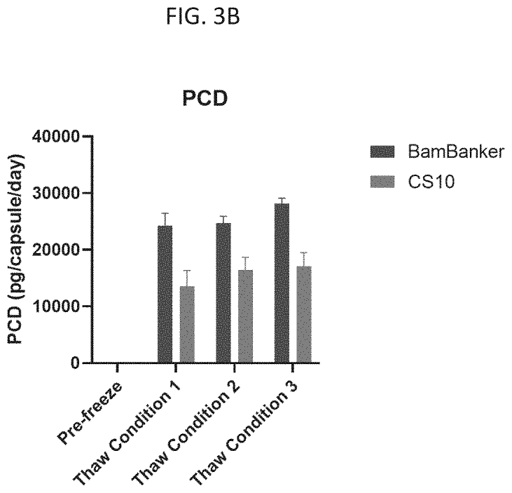

BAMBANKER™ (BulldogBio, P/N: BB01; without DMF; used as control), and CryoStor® CS10 (BioLife Solutions, P/N: 07930) allowed viabilities of greater than 70% post-thawing, as shown in FIG. 3A, with the higher ratios of media generally allowing better cell viability. Antigen production was evaluated for each condition, and is as shown in FIG. 3B. Post-thaw antigen production in encapsulated cells cryopreserved using CryoStor® CS10 was comparable to fresh levels; however, antigen production in encapsulated cells cryopreserved using BAMBANKER™ was higher than typical. Accordingly, BAMBANKER™ (BulldogBio, P/N: BB01; without DMF; used as control), and CryoStor® CS10 (BioLife Solutions, P/N: 07930) maintain viability of encapsulated cells.

All of the compositions and methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and methods and in the steps or in the sequence of steps of the method described herein without departing from the concept, spirit and scope of the disclosure. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the disclosure as defined by the appended claims.

All publications, patent applications, patents, and other references mentioned herein are incorporated by reference in their entirety and for the purpose as context dictates.

What is claimed:

1. A method of cryopreserving or freezing a population of encapsulated cells comprising a plurality of oligonucleotide molecules encoding a heterologous molecule, the method comprising:
contacting the encapsulated cells in a container with an effective amount of a cryopreservation media to form cryopreservation composition, wherein the cryopreservation media comprises at about 7 to about 12% dimethylsulfoxide (DMSO) and at least one other component;
incubating the container comprising the cryopreservation composition at a temperature of about 18° C. to about 25° C.; and
cooling the incubated container comprising the cryopreservation composition at rate of 1-5° C. to a temperature sufficient to cryopreserve the encapsulated cells.

2. The method of claim 1, wherein the at least one other component is propylene glycol, ethylene glycol, or polyethylene glycol.

3. The method of claim 1, wherein the cryopreservation media comprises BAMBANKER™ BAMBANKER™ HRM, CryoStor® CS10, CryoStor® CS5, CTS™ Synth-a-Freeze™, human serum albumin (HAS), glycerol, propylene glycol (PG), ethylene glycol (EG), polyethylene glycol (PEG), and any combination thereof.

4. The method of claim 1, wherein the cryopreservation composition is incubated at room temperature for about 1 to about 10 minutes, about 5 to about 15 minutes, about 10 minutes, 15 minutes, about 20 minutes, about 25 minutes, about 30 minutes, about 35 minutes, about 40 minutes, about 45 minutes, about 50 minutes, about 55 minutes, or about 60 minutes prior to cooling.

5. The method of claim 1, wherein the temperature sufficient to cryopreserve the encapsulated cells is about −70° C. to about −200° C.

6. The method of claim 1, wherein the cooling container comprises placing the container in an ethanol solution and in a freezer that is at a temperature from about −70° C. to about −200° C.

7. The method of claim 1, wherein the cryopreservation media comprises a sugar.

8. The method of claim 1, wherein the cryopreservation media does not comprise plasmalyte.

9. The method of claim 1, wherein the encapsulated cells retain about 10 to about 40% viability, about 40% to about 70% viability, at least 40% viability, at least 50% viability, at least 60% viability, at least 70% viability, at least 80% viability, or at least 90% viability after being frozen in the cryopreservation media for about, or at least, 1 day, 1 week, 1 month, 2 months, 3 months, 4 months, 5 months, 6 months, 9 months, or 12 months.

10. The method of claim 1, wherein the encapsulated cells have a diameter of about 1 to about 2 mm, about 1 mm, about 1.5 mm, or about 2 mm.

11. The method of claim 1, wherein the heterologous molecule is a cytokine.

12. The method of claim 11, wherein the cytokine is selected from IL-2, IL-12, IL-1, IL-1α, IL-1β, IL-1RA, IL-4, IL-5, IL-6, IL-7, IL-8, IL-9, IL-10, IL-11, IL-12a, IL-12b, IL-13, IL-14, IL-16, IL-17, G-CSF, GM-CSF, IL-20, IFN-α, IFN-β, IFN-γ, CD154, LT-β, CD70, CD153, CD178, TRAIL, TNF-α, TNF-β, SCF, M-CSF, MSP, 4-1BBL, LIF, and OSM.

13. The method of claim 1, wherein the cells are ARPE-19 cells, ARPE-19-SEAP-2-neo cells, RPE-J cells, hTERT RPE-1 cells, or any combination thereof.

14. The method of claim 1, wherein the cells are encapsulated with a polymeric hydrogel.

15. The method of claim 14, wherein the polymeric hydrogel comprises alginate.

16. The method of claim 15, wherein the alginate comprises SLG20, VLVG (very low viscosity alginate), LVG (low viscosity alginate), MVG (medium viscosity alignate), or SLG100.

17. A method of maintaining viability of a population of encapsulated cells, the method comprising the steps of:
adding an effective amount of a cryopreservation media to a container comprising the population of encapsulated cells to form a contain comprising a cryopreservation composition, wherein the cryopreservation media comprises at least 7-12% dimethylsulfoxide (DMSO) and at least one other component;
incubating the container comprising the cryopreservation composition at temperature of about 18 to about 25° C. prior to cooling;
cooling the container comprising the cryopreservation composition at rate of 1-5° C. to a temperature sufficient to cryopreserve the cells;
maintaining the container comprising the cryopreservation composition at a temperature sufficient to cryopreserve the cells; and
thawing the cryopreservation composition under conditions sufficient to maintain viability of the population of encapsulated cells.

18. A method of thawing a cryopreserved composition comprising a plurality of encapsulated cells, wherein the cryopreservation composition is prepared according to a method of claim 1, wherein the thawing comprises the steps of:
thawing the cryopreservation composition;
washing the population of encapsulated cells; and
replacing the cryopreservation media with basal media.

19. A frozen or thawed composition preparing according to a method of claim 1.

20. A composition comprising encapsulated cells comprising about 7 to about 12% dimethylsulfoxide (DMSO) and at least one other component, wherein the encapsulated cells comprise a nucleic acid molecule encoding a heterologous molecule.

21. The composition of claim 20, wherein the at least one other component is propylene glycol (PG), polyethylene glycol, or ethylene glycol (EG).

22. A method of treating a subject with a disease or condition, the method comprising thawing a cryopreserved composition preparing according to claim 1 and administering the thawed encapsulated cells to the subject.
